(19) United States
(12) Patent Application Publication
(10) Pub. No.: US 2025/0324294 A1
(43) Pub. Date: Oct. 16, 2025

(54) REFERENCE SIGNAL CONFIGURATION FOR LINK MONITORING IN A DEACTIVATED CELL

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/866,051

(22) PCT Filed: Jul. 15, 2022
(86) PCT No.: PCT/CN2022/105937

§ 371 Date: Nov. 14, 2024

(51) Int. Cl. H04W 24/08; H04B 7/06; H04L 5/00; H04W 36/04

(52) U.S. Cl. CPC H04W 24/08; H04B 7/0626; H04B 7/06968; H04L 5/0051; H04W 36/04

(57) ABSTRACT

The apparatus may be a wireless device configured to receive a first indication of a set of resources for one of (1) monitoring for a failure event or (2) measuring CSI associated with a corresponding set of deactivated cells associated with the wireless device for L1/L2 mobility. The apparatus may further be configured to (1) detect a failure event associated with a beam of at least one deactivated cell in the set of deactivated cells by monitoring the set of resources or (2) measure, based on the CSI resource configuration, CSI associated with resources in the set of resources for at least one deactivated cell in the set of deactivated candidate cells. The apparatus may further be configured to transmit, for an active cell, (1) a second indication of the detected failure event or (2) information regarding the measured CSI for the at least one deactivated cell.

### TECHNICAL FIELD

The present disclosure relates generally to communication systems, and more particularly, to a dynamic switch mechanism among candidate serving cells for cell layer 1 or layer 2 (L1/L2) mobility associated with a wireless device, e.g., a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus, in some aspects, may be a wireless device (e.g., a UE or UE component). The apparatus may be configured to receive a first indication of a set of resources for monitoring for a failure event associated with a corresponding set of deactivated cells of candidate cells associated with the wireless device for L1/L2 mobility. The apparatus may further be configured to detect a failure event associated with a beam of at least one deactivated cell in the set of deactivated cells of candidate cells by monitoring the set of resources and transmit, for an active cell, a second indication of the detected failure event.

In an aspect of the disclosure, a method, a computer-readable medium, and an apparatus are provided. The apparatus, in some aspects, may be a wireless device (e.g., a UE or UE component). The apparatus may be configured to receive a channel state information (CSI) resource configuration indicating a set of resources for measuring CSI associated with a corresponding set of deactivated candidate cells associated with the wireless device for L1/L2 mobility. The apparatus may further be configured to measure, based on the CSI resource configuration indicating the set of resources, CSI associated with resources in the set of resources for at least one deactivated cell in the set of deactivated candidate cells and transmit, for an active cell, information regarding the measured CSI for the at least one deactivated cell.

In an aspect of the disclosure, a method, a computer-readable medium, and an apparatus are provided. The apparatus, in some aspects, may be a network node (e.g., a base station, base station component, a network entity, or a network entity component). The apparatus may be configured to transmit a first indication of a set of resources for monitoring for a failure event associated with a corresponding set of deactivated cells of candidate cells associated with a wireless device for L1/L2 mobility. The apparatus may further be configured to receive, based on the set of resources, a second indication of a detected failure event associated with a beam of at least one deactivated cell in the set of deactivated cell of candidate cells and the wireless device.

In an aspect of the disclosure, a method, a computer-readable medium, and an apparatus are provided. The apparatus, in some aspects, may be a network node (e.g., a base station, base station component, a network entity, or a network entity component). The apparatus may be configured to transmit a CSI resource configuration indicating a set of resources for measuring CSI associated with a corresponding set of deactivated candidate cells associated with a wireless device for L1/L2 mobility. The apparatus may further be configured to receive, based on the set of resources, information regarding the measured CSI for at least one deactivated cell.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating an environment in which a method or apparatus of the disclosure may be employed in some aspects.

FIG. 5 is a diagram illustrating an environment in which a method or apparatus of the disclosure may be employed in some aspects.

FIG. 6 is a call flow diagram illustrating a method for configuring failure detection resources for a UE to use to monitor beams and/or radio links associated with a set of candidate and/or deactivated cells and reporting a detected failure event to an active cell.

FIG. 7 is a call flow diagram illustrating a method for configuring channel measurement resources for a UE to use to measure channel information associated with a set of candidate and/or deactivated cells and reporting a detected failure to an active cell.

FIG. 8 is a diagram illustrating a modified information element for configuring a CSI report for one or more deactivated cells in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an apparatus.

FIG. 18 is a diagram illustrating an example of a hardware implementation for a network entity.

FIG. 19 is a diagram illustrating an example of a hardware implementation for a network entity.

### DETAILED DESCRIPTION

In some aspects, of wireless communication, a single wireless device may be associated with multiple different cells (e.g., one or more network nodes or TRPs in each of the different cells). The different cells (or network nodes) may be candidate cells that may be selected to act as one of a primary cell (PCell), a secondary cell (SCell), a primary secondary cell (PSCell), or a special cell (SpCell). In some aspects, a Pcell, SpCell, or a PSCell may provide a control plane connection to a core network while an SCell and/or PSCell may provide additional communication resources to the wireless device (e.g., for multi radio dual connectivity). An SpCell, as used herein may correspond to a PCell or a PSCell, e.g., to a primary cell for either a primary cell group (e.g., PCell) or a secondary cell group (e.g., PSCell). In some aspects, an SCell or PSCell may be deactivated. For example, if the additional communication resources are not needed, an SCell or PSCell may be temporarily deactivated.

While deactivated, the wireless device may experience (or be subject to) a beam failure or radio link failure with one or more SCells or PSCells. The beam and/or radio link failure may not be detected by the wireless device until the wireless device attempts to activate a deactivated SCell and/or PSCell. A time taken to activate the deactivated SCell and/or PSCell (e.g., a latency of the activation) after an undetected failure event may be larger than an expected time for activating a deactivated SCell and/or PSCell with a functioning beam and/or radio link. The additional latency, in some, aspects, may affect communication via the set of active (or activated) cells.

Additionally, or alternatively, the wireless device, in some aspects, may experience a L1/L2 mobility event (e.g., a change of position or orientation relative to a set of cells or candidate cells associated with the wireless device). During the mobility event, the different cells may become more or less favorable/desirable for serving as a PCell, SpCell, SCell, or PSCell based on distance and/or channel quality (e.g., based on physical blockages, orientation, etc.). As for beam and/or radio link failure, the change in the favorability/desirability of a deactivated SCell and/or PCell, e.g., a change in channel quality, may not be detected by the wireless device until the wireless device attempts to activate a deactivated SCell and/or PSCell. The deactivated SCell and/or PSCell selected for activation, in some aspects, may be based on inaccurate (e.g., out-of-date) information and may lead to the selection of a non-optimal deactivated SCell and/or PSCell for activation. Additionally, beam management for selecting a beam for the SCell and/or PSCell selected for activation may introduce additional time (e.g., additional latency) between activation of, and communication with, the SCell and/or PSCell selected for activation.

In some aspects of the disclosure, a method and apparatus are presented that configure resources for performing, for a wireless device, beam failure and/or radio link failure detection for deactivated network nodes associated with candidate cells associated with the wireless device. By reporting failure of a beam and/or radio link of a deactivated network node, the network and/or wireless device may be able to make a more optimal selection of a cell and/or network node to activate or to designate as a SCell or PSCell. The more optimal selection may be a selection that reduces a latency associated with activating a selected, deactivated network node and/or cell or a handover to a SCell or PSCell to act as a PCell or SpCell.

A method and apparatus, in some aspects of the disclosure, are presented that configure resources for a wireless device for (1) performing channel measurements (e.g., associated with CSI) and (2) reporting CSI for deactivated network nodes associated with candidate cells associated with the wireless device. By reporting the CSI associated with the deactivated network nodes associated with the candidate cells, the network and/or wireless device may be able to make a more optimal selection of a cell and/or network node to activate and or designate as a PCell. For example, the latency time (e.g., including a beam training time) or the channel quality may be optimized when selecting a deactivated network node to activate or a candidate cell to designate as a PCell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

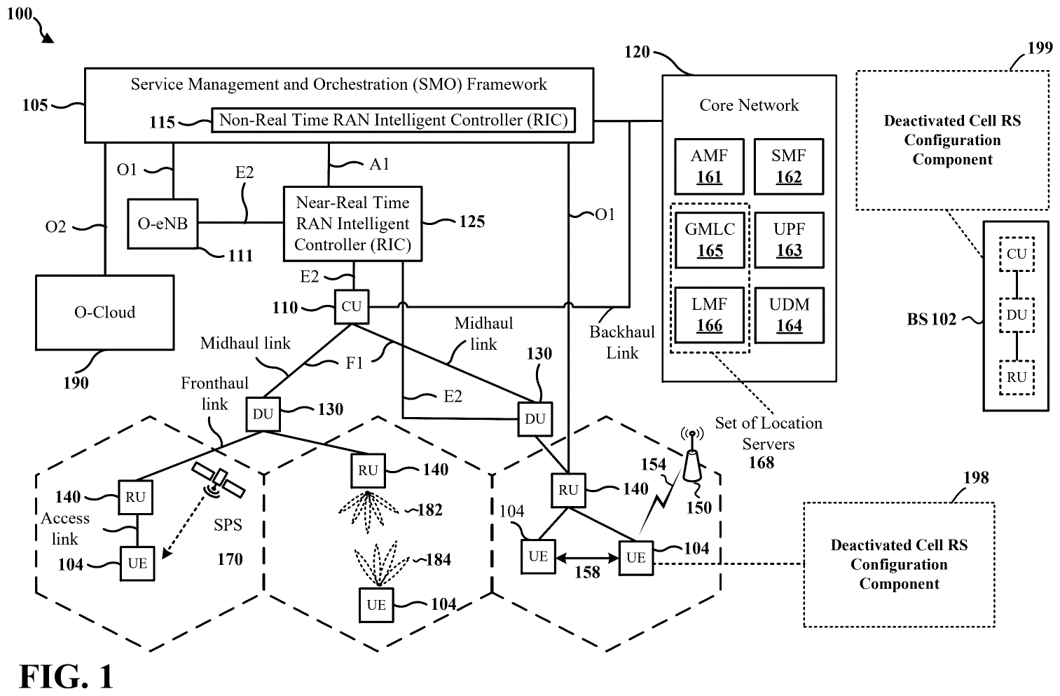

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a deactivated cell RS configuration component 198 that may be configured to receive a first indication of a set of resources for monitoring for a failure event associated with a corresponding set of deactivated cells of candidate cells associated with the wireless device for L1/L2 mobility. The deactivated cell RS configuration component 198 may further be configured to detect a failure event associated with a beam of at least one deactivated cell in the set of deactivated cells of candidate cells by monitoring the set of resources and transmit, for an active cell, a second indication of the detected failure event. In some aspects the deactivated cell RS configuration component 198 may be configured to receive a CSI resource configuration indicating a set of resources for measuring CSI associated with a corresponding set of deactivated candidate cells associated with the wireless device for L1/L2 mobility. The deactivated cell RS configuration component 198 may further be configured to measure, based on the CSI resource configuration indicating the set of resources, CSI associated with resources in the set of resources for at least one deactivated cell in the set of deactivated candidate cells and transmit, for an active cell, information regarding the measured CSI for the at least one deactivated cell.

In certain aspects, the base station 102 may include a deactivated cell RS configuration component 199 that may be configured to transmit a first indication of a set of resources for monitoring for a failure event associated with a corresponding set of deactivated cells of candidate cells associated with a wireless device for L1/L2 mobility and receive, based on the set of resources, a second indication of a detected failure event associated with a beam of at least one deactivated cell in the set of deactivated cell of candidate cells and the wireless device. The deactivated cell RS configuration component 199 may additionally, or alternatively, be configured to transmit a CSI resource configuration indicating a set of resources for measuring CSI associated with a corresponding set of deactivated candidate cells associated with a wireless device for L1/L2 mobility and receive, based on the set of resources, information regarding the measured CSI for at least one deactivated cell. Although the following description may be focused on 5G NR, the concepts described herein may be applicable to other similar areas, such as LTE, LTE-A, CDMA, GSM, and other wireless technologies.

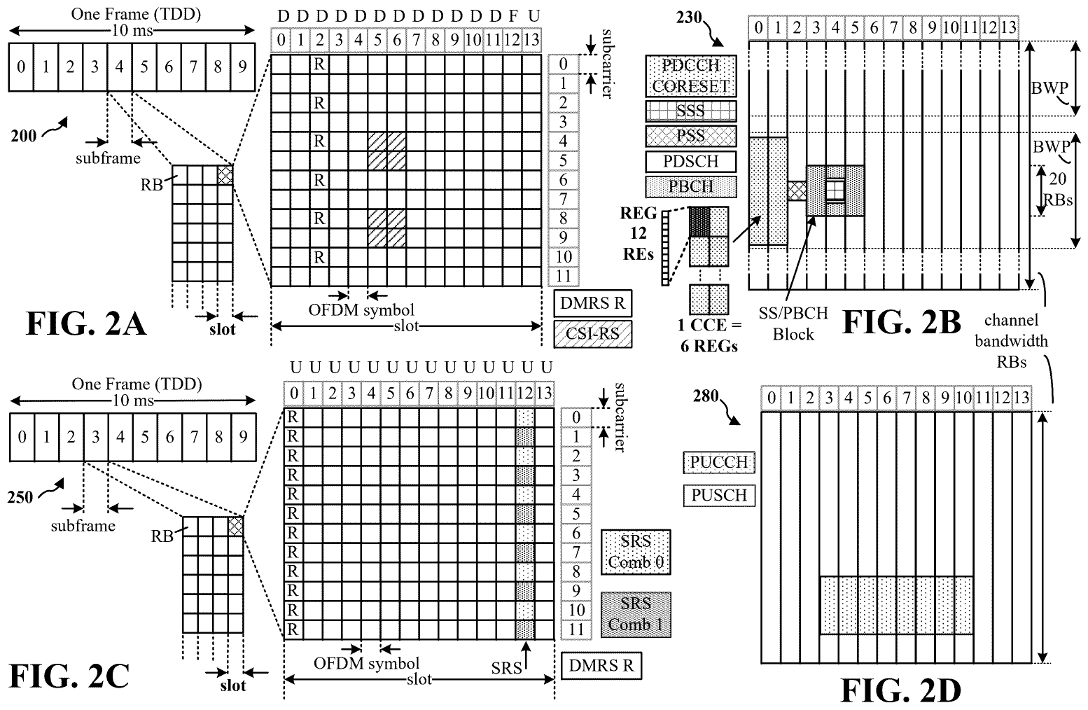

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δƒ = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

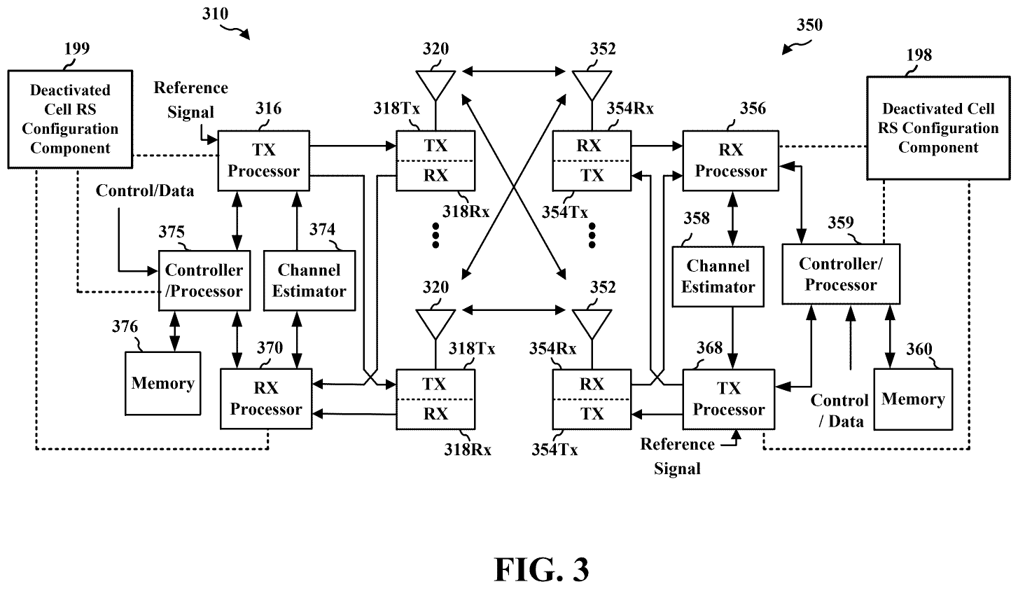

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the deactivated cell RS configuration component 198 of FIG. 1.

At least one of the TX processor 316, the RX processor 370, and the controller/processor 375 may be configured to perform aspects in connection with the deactivated cell RS configuration component 199 of FIG. 1.

In some aspects, of wireless communication, a single wireless device may be associated with multiple different cells (e.g., one or more network nodes or TRPs in each of the different cells). The different cells (or network nodes) may be candidate cells that may be selected to act as one of a PCell, a SCell, a PSCell, or a SpCell. In some aspects, a Pcell, SpCell, or PSCell may provide a control plane connection to a core network while an SCell or PSCell may provide additional communication resources to the wireless device (e.g., for multi radio dual connectivity). An SpCell, as used herein may correspond to a PCell or a PSCell, e.g., to a primary cell for either a primary cell group (e.g., PCell) or a secondary cell group (e.g., PSCell). In some aspects, an SCell or PSCell may be deactivated. For example, if the additional communication resources are not needed, an SCell or PSCell may be temporarily deactivated.

While deactivated, the wireless device may experience (or be subject to) a beam failure or radio link failure with one or more SCells or PSCells. The beam and/or radio link failure may not be detected by the wireless device until the wireless device attempts to activate a deactivated SCell and/or PSCell. A time taken to activate the deactivated SCell and/or PSCell (e.g., a latency of the activation) after an undetected failure event may be larger than an expected time for activating a deactivated SCell and/or PSCell with a functioning beam and/or radio link. The additional latency, in some, aspects, may affect communication via the set of active (or activated) cells.

Additionally, or alternatively, the wireless device, in some aspects, may experience a L1/L2 mobility event (e.g., a change of position or orientation relative to a set of cells or candidate cells associated with the wireless device). During the mobility event, the different cells may become more or less favorable/desirable for serving as a PCell, SpCell, SCell, or PSCell based on distance and/or channel quality (e.g., based on physical blockages, orientation, etc.). As for beam and/or radio link failure, the change in the favorability/desirability of a deactivated SCell and/or PCell, e.g., a change in channel quality, may not be detected by the wireless device until the wireless device attempts to activate a deactivated SCell and/or PSCell. The deactivated SCell and/or PSCell selected for activation, in some aspects, may be based on inaccurate (e.g., out-of-date) information and may lead to the selection of a non-optimal deactivated SCell and/or PSCell for activation. Additionally, beam management for selecting a beam for the SCell and/or PSCell selected for activation may introduce additional time (e.g., additional latency) between activation of, and communication with, the SCell and/or PSCell selected for activation.

In some aspects of the disclosure, a method and apparatus are presented that configure resources for performing, for a wireless device, beam failure and/or radio link failure detection for deactivated network nodes associated with candidate cells associated with the wireless device. By reporting failure of a beam and/or radio link of a deactivated network node, the network and/or wireless device may be able to make a more optimal selection of a cell and/or network node to activate or to designate as a SCell or PSCell. The more optimal selection may be a selection that reduces a latency associated with activating a selected, deactivated network node and/or cell or a handover to a SCell or PSCell to act as a PCell or SpCell.

A method and apparatus, in some aspects of the disclosure, are presented that configure resources for a wireless device for (1) performing channel measurements (e.g., associated with CSI) and (2) reporting CSI for deactivated network nodes associated with candidate cells associated with the wireless device. By reporting the CSI associated with the deactivated network nodes associated with the candidate cells, the network and/or wireless device may be able to make a more optimal selection of a cell and/or network node to activate and or designate as a PCell. For example, the latency time (e.g., including a beam training time) or the channel quality may be optimized when selecting a deactivated network node to activate or a candidate cell to designate as a PCell.

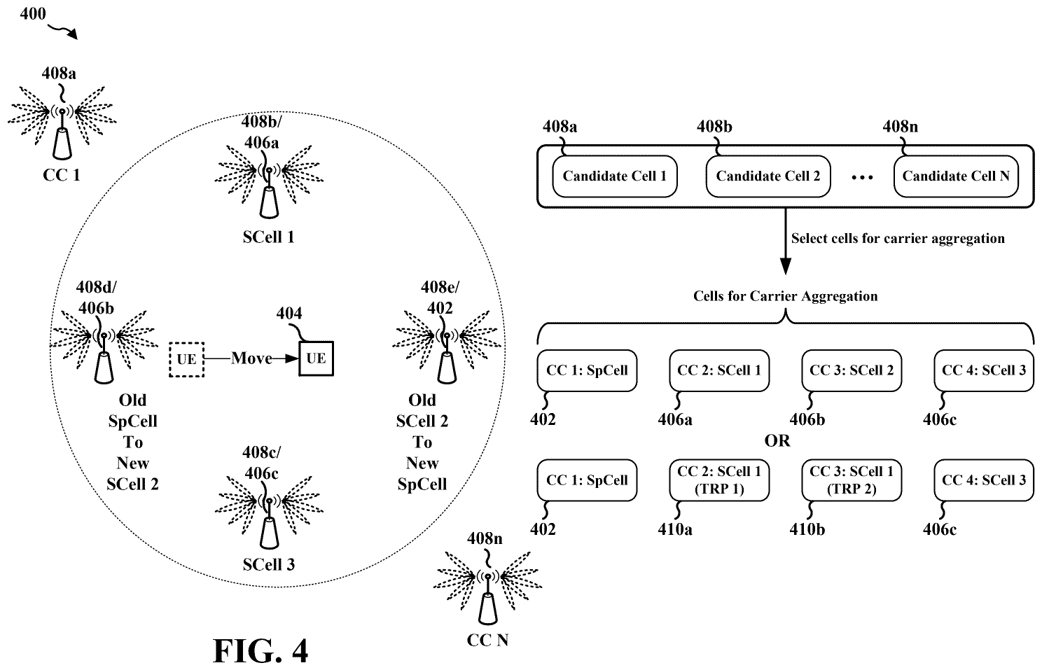

FIG. 4 is a diagram 400 illustrating an environment in which a method or apparatus of the disclosure may be employed in some aspects. Diagram 400 illustrates a UE 404 in communication with a SpCell 402 (e.g., a base station, network node, TRP, etc.) after a mobility event (e.g., a movement). The SpCell may be a PCell or may be a PSCell, for example. The SpCell 402 may be selected from a set of candidate cells including a set of “N” candidate cells (e.g., including candidate cell 1 408a, candidate cell 2 408b, candidate cell 408d, candidate cell 408e, and candidate cell N 408n illustrated in diagram 400). As illustrated, an additional set of three SCells (e.g., SCell 1 406a, SCell 2 406b, and SCell 3 406c) may be selected for carrier aggregation associated with the UE 404. In some aspects, the set of selected SCells may include multiple TRPs, e.g., TRP 1 410a and TRP 2 410b, associated with a same SCell.

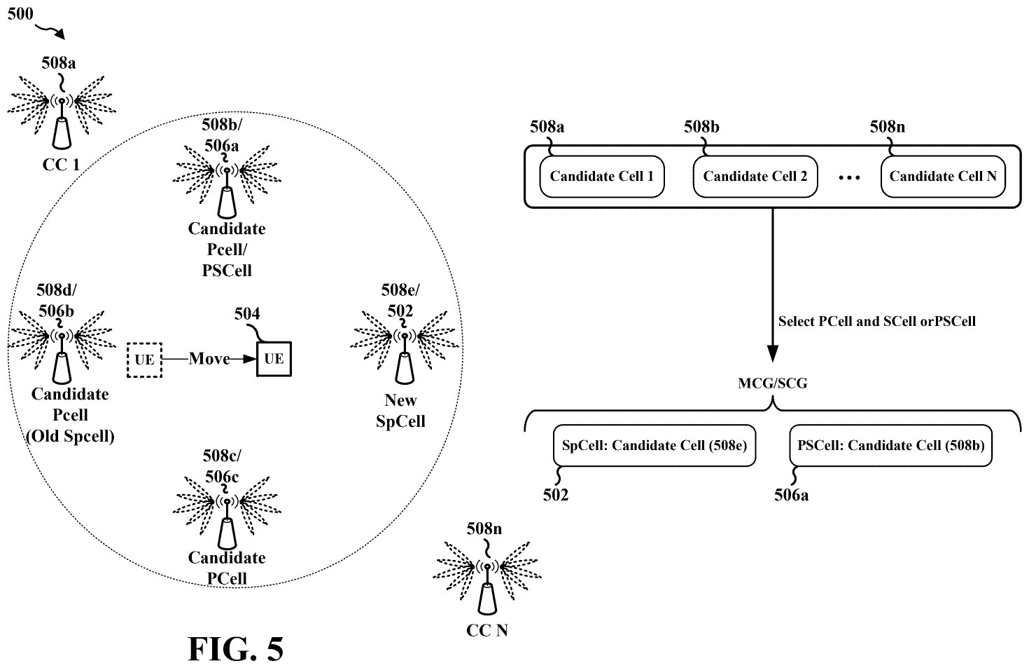

FIG. 5 is a diagram 500 illustrating an environment in which a method or apparatus of the disclosure may be employed in some aspects. Diagram 500 illustrates a UE 504 in communication with a SpCell 502 (e.g., a base station, network node, TRP, etc.) after a mobility event (e.g., a movement). The SpCell 502 may be selected from a set of candidate cells including a set of “N” candidate cells (e.g., candidate cell 1 508a, candidate cell 2 508b, candidate cell 508d, candidate cell 508e, and candidate cell N 508n illustrated in diagram 500). A PSCell 506a, in some aspects, may also be selected from the set of “N” candidate cells where the SpCell 502 and the PSCell 506a make up one of a master cell group (MCG) or a secondary cell group (SCG). As illustrated, an additional set of candidate PCells (e.g., candidate PCell 506b and candidate PCell 506c) may be identified as being potential PCells currently and/or for a subsequent handover operation associated with the UE 504.

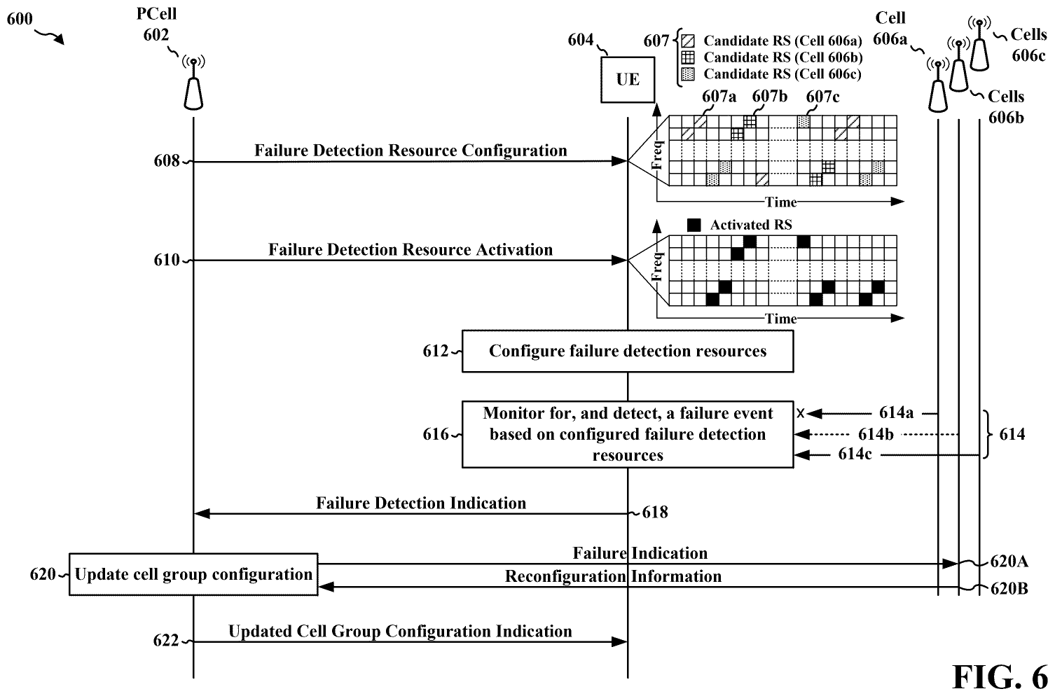

FIG. 6 is a call flow diagram 600 illustrating a method for configuring failure detection resources for a UE 604 to use to monitor beams and/or radio links associated with a set of candidate (e.g., SCell) and/or deactivated cells (e.g., one or more of cell 606a, cell 606b, and cell 606c) and reporting a detected failure event to a PCell 602. The use of the labels PCell and SCell when referring to the PCell 602 and the cells 606a-c, respectively, do not limit the implementation to any particular type of “cell” and may apply to any type of network node, TRP, or access point.

A PCell 602 may transmit, and UE 604 may receive, a failure detection resource configuration 608. The failure detection resource configuration 608, in some aspects, may be one of (1) transmitted/received via a RRC signal, (2) known, or (3) an update to a previously-received indication of a different set of resources transmitted/received via a MAC-CE. The failure detection resource configuration 608 may indicate a set of resources 607 for monitoring for a failure event associated with a corresponding set of deactivated cells of candidate cells (e.g., cells 606a-c) associated with the UE 604. In some aspects, the set of resources 607 may include resources for receiving reference signals from the set of deactivated cells (e.g., cells 606a-c).

The failure detection resource configuration 608, in some aspects, may include an explicit indication of a plurality of subsets of resources, e.g., subset of resources 607a, subset of resources 607b, and subset of resources 607c in the set of resources 607. Each subset of resources 607a-c, in some aspects, may be associated with a particular deactivated network node in the set of deactivated cells. For example, the subset of resources 607a may be associated with cell 606a, the subset of resources 607b may be associated with cell 606b, and the subset of resources 607c may be associated with cell 606c. In some aspects, failure detection resource configuration 608 (e.g., an indication of the set of resources) may include at least two subsets of resources associated with different TRPs of a same deactivated cell (e.g., if any two of cell 606a-c represent different TRPs of a same deactivated network node/cell). In some aspects, failure detection resource configuration 608 may not explicitly include a subset of resources associated with a deactivated cell. For example, the UE 604 may determine one subset of resources based on the QCL assumptions of CORESETs configured in the deactivated network node/cell. For another example, when configured with different CORESET pool indexes for supporting mDCI based mTRP operation in a deactivated network node/cell, the UE 604 may determine two subsets of resources based on the QCL assumptions of CORESETs of different CORESET pool indexes configured with the deactivated network node/cell.

The PCell 602 (or any other active cell) may transmit, and UE 604 may receive, a failure detection resource activation 610. In some aspects, the failure detection resource activation 610 (e.g., an activation indication) may be transmitted/received via one of (1) a MAC-CE or (2) DCI. The failure detection resource activation 610, in some aspects, may activate at least one subset of resources (e.g., one or more of the subsets of resources 607a-c) of the set of resources 607 for monitoring for the failure event. For example, the failure detection resource activation 610 may indicate for the UE 604 to activate the subsets of resources 607b and 607c associated with deactivated cells 606b and 606c, respectively. In some aspects, a timing between receiving the failure detection resource activation 610 and activating the at least one subset of resources occurs may be based on a fixed timing offset (e.g., based on a number of slots, symbols, or milliseconds).

Based on the failure detection resource configuration 608 and the failure detection resource activation 610, the UE 604 may configure, at 612, failure detection resources for monitoring for a failure event associated with the indicated cells (e.g., 606b and 606c). In some aspects, configuring the failure detection resources at 612 may include performing a prioritization operation over the at least one subset of resources of the set of resources for monitoring for the failure event and a set of resources for monitoring for a failure of a network node of an active cell (e.g., PCell 602) to ensure that the at least one subset of resources of the set of resources for monitoring for the failure event and the set of resources for monitoring for the failure of the network node of the active cell includes no more than a maximum number of resources. The maximum number of resources to be used for monitoring for the failure event, in some aspects, may be based on a capability reported by the wireless device.

The UE 604 may then, based on the failure detection resource activation 610 and the configuration at 612, monitor, at 616, a set of transmissions 614 from the set of deactivated cells associated with the beam and/or radio link failure detection. The monitored set of transmissions may include a subset of the transmissions indicated in the failure detection resource activation 610 (e.g., transmission 614b and transmission 614c but not transmission 614a) from the full set of transmissions 614 that are indicated in the failure detection resource configuration 608. Based on the configured failure detection resources (e.g., the monitored set of transmissions), the UE 604 may detect a failure event at 616 associated with at least one deactivated cell (e.g., cell 606b). In some aspects, the failure event associated with the at least one deactivated cell in the set of deactivated cells may be detected by monitoring the at least one subset of resources. For example, at 616, by monitoring resources in the subset of resources 607b associated with cell 606b, the UE 604 may determine that transmission 614b indicates a failure of a beam or radio link between the UE 604 and the cell 606b (e.g., based on a failure to receive the transmission 614b from cell 606b).

Based on the failure detected at 616, the UE 604 may transmit and the PCell 602 may receive, failure detection indication 618. The failure detection indication 618, in some aspects, may include an identification of the failed cell 606b. The PCell 602 (or a network entity connected to the PCell 602), in some aspects, may then update, at 620, a cell group configuration. The update, in some aspects, may be based on a set of transmissions between the PCell 602 and a failed cell 606b (e.g., a PSCell) including a failure indication 620A and/or a reconfiguration information 620B. In some aspects, the PCell 602 may transmit, and the UE 604 may receive, an updated cell group configuration indication 622. The updated cell group configuration indication 622 may include one of a same set of cells with an updated set of designations (e.g., PSCells or SCells) or a different set of cells. In some aspects, the updated cell group configuration indication 622 may include an updated configuration associated with at least one deactivated and/or candidate cell. The PCell 602 may then perform a similar set of operations to those described in relation to FIG. 6 based on the updated cell group configuration indication 622.

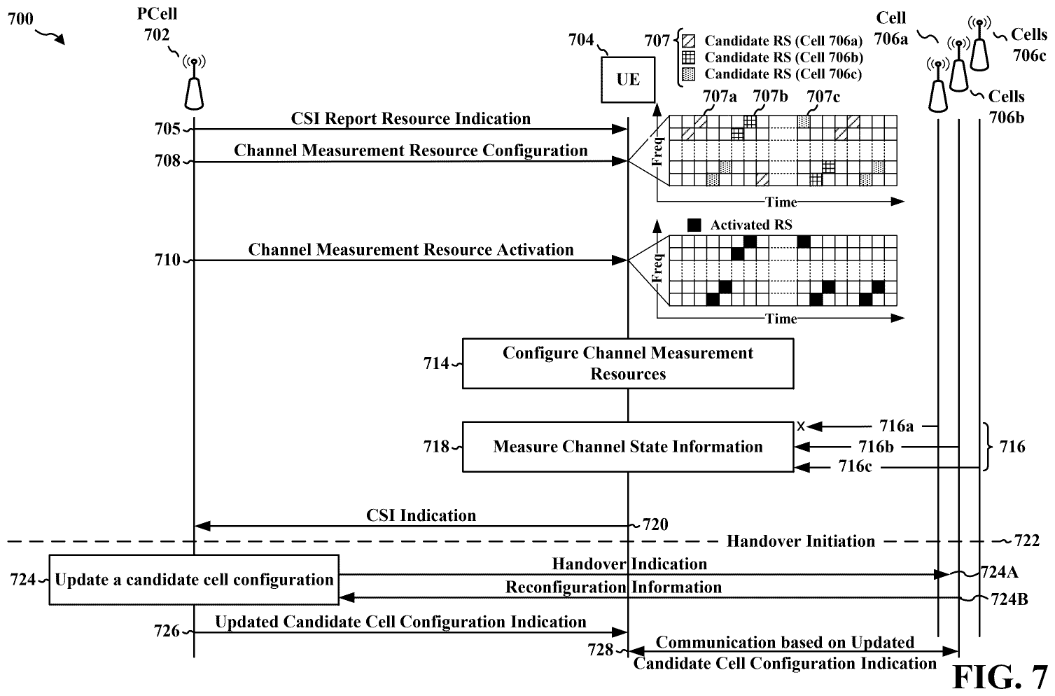

FIG. 7 is a call flow diagram 700 illustrating a method for configuring channel measurement resources for a UE 704 to use to measure channel information associated with a set of candidate (e.g., SCell) and/or deactivated cells (e.g., one or more of cell 706a, cell 706b, and cell 706c) and reporting a detected failure to a PCell 702. The use of the labels PCell and SCell when referring to the PCell 702 and the cells 706a-c, respectively, should not be construed as limiting the implementation to any particular type of “cell” and may apply to any type of network node, TRP, or access point.

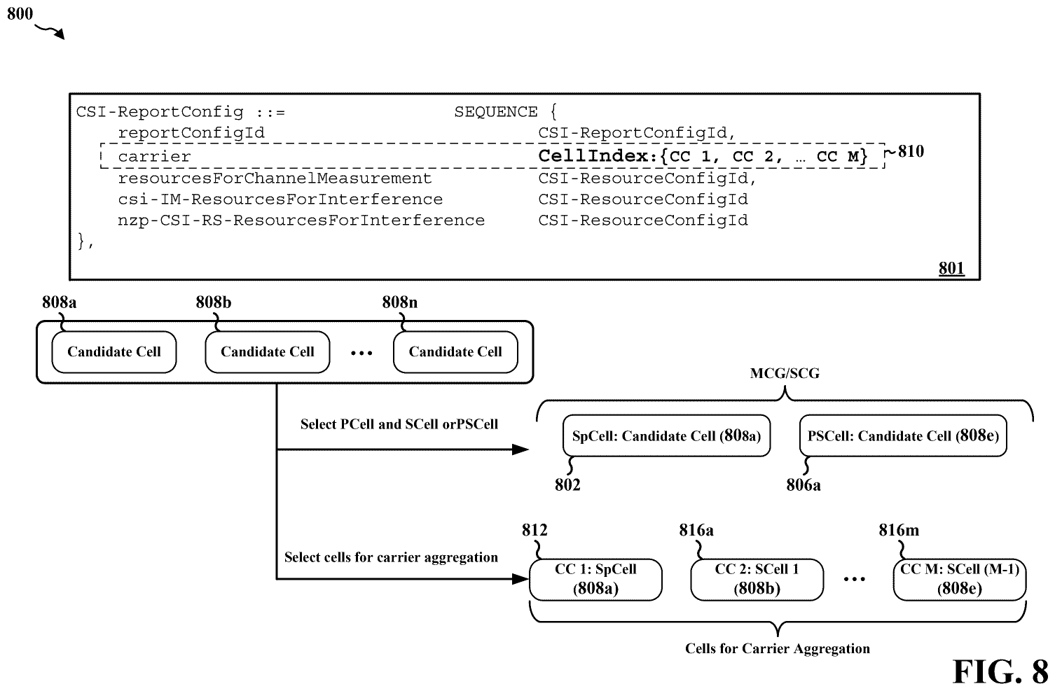

The PCell 702, in some aspects, may transmit a CSI report configuration indication 705 indicating one of a set of periodic resources, a set of semi-persistent resources, or a set of aperiodic resources for transmitting information regarding the measured CSI for the at least one deactivated cell. The CSI report configuration indication 705 may include a modified CSI-ReportConfig information element (IE) 801 as illustrated in FIG. 8. FIG. 8 is a diagram 800 illustrating a modified information element for configuring a CSI report for one or more deactivated cells in accordance with some aspects of the disclosure. As illustrated in FIGS. 4 and 5, a wireless device may be associated with a set of candidate cells (e.g., candidate cell 808a, candidate cell 808b, through candidate cell 808n) from which members of a MCG and/or SCG (e.g., including SpCell 802 and PS Cell 806a) or a set of cells for carrier aggregation (e.g., including SpCell 812, SCell 816a, and SCell 816m corresponding to candidate cells 808a, 808b, and 808e, respectively) may be selected. The CSI-ReportConfig IE 801 may include a carrier field 810 that, in some aspects, may include a cell index associated with one or more (non-PCell) deactivated and/or candidate cells (e.g., PSCell 806a and/or SCell 816a to SCell 816m) that are associated with a wireless device (e.g., UE 704). For example, the CSI report configuration indication 705 transmitted by the PCell 702, and received by the UE 704, may include the CSI-ReportConfig IE 801 indicating the set of cells for which the PCell 702 configures the UE 704 to report CSI to the PCell 702. In some aspects, the CSI report configuration indication 705 may indicate a set of semi-persistent resources associated with a PUCCH and the CSI report configuration indication 705 may be received via a MAC-CE associated with PCell 702. The CSI report configuration indication 705, in some aspects, may indicate one of a set of semi-persistent resources associated with a PUSCH or a set of aperiodic resources associated with the PUSCH and the CSI report configuration may be received via DCI associated with the PCell 702.

In some aspects, the PCell 702 may transmit, and UE 704 may receive, a channel measurement resource configuration 708. The channel measurement resource configuration 708, in some aspects, may be one of (1) transmitted/received via a RRC signal, (2) known, or (3) an update to a previously-received indication of a different set of resources transmitted/received via a MAC-CE. The channel measurement resource configuration 708 may indicate a set of resources 707 for channel measurement for a corresponding set of deactivated cells of candidate cells (e.g., cells 706a-706c) associated with the UE 704. The set of resources 707, in some aspects, includes at least one of channel measurement resources or interference measurement resources. In some aspects, the set of resources 707 may include reference signal resources for the set of deactivated cells (e.g., cells 706a-706c).

The channel measurement resource configuration 708, in some aspects, may include an indication of a plurality of subsets of resources, e.g., subset of resources 707a, subset of resources 707b, and subset of resources 707c in the set of resources 707. Each subset of resources 707a-707c, in some aspects, may be associated with a particular deactivated cell in the set of deactivated cells. For example, the subset of resources 707a may be associated with cell 706a, the subset of resources 707b may be associated with cell 706b, and the subset of resources 707c may be associated with cell 706c. In some aspects, each subset of resources includes one of periodic resources, semi-persistent (SP) resources, or aperiodic (AP) resources. In some aspects, the configuration information described in relation to the channel measurement resource configuration 708 is indicated by the CSI report configuration indication 705 (e.g., by the CSI-ReportConfig IE 801). In such aspects, transmitting the channel measurement resource configuration 708 may be performed by transmitting the CSI report configuration indication 705.

The PCell 702 may transmit, and UE 704 may receive, a channel measurement resource activation 710. In some aspects, the channel measurement resource activation 710 (e.g., an activation indication) may be transmitted/received via one of (1) a MAC-CE or (2) DCI. For example, for periodic or SP resources, the channel measurement resource activation 710, in some aspects may be transmitted/received via a MAC-CE or DCI on any active cell (e.g., PCell 702) for activating the periodic or SP CSI resources. In some aspects, for aperiodic resources, the channel measurement resource activation 710 may be transmitted/received via DCI on any active cell (e.g., PCell 702) for activating the AP CSI resources. The channel measurement resource activation 710, in some aspects, may activate at least one subset of resources (e.g., one or more of the subsets of resources 707a-c) of the set of resources 707 for channel (e.g., CSI) measurement. For example, the channel measurement resource activation 710 may indicate for the UE 704 to activate the subsets of resources 707b and 707c associated with deactivated cells 706b and 706c, respectively. In some aspects, a timing between receiving the channel measurement resource activation 710 and activating the at least one subset of resources occurs may be based on a fixed timing offset (e.g., based on a number of slots, symbols, or milliseconds).

Based on the channel measurement resource configuration 708 and the channel measurement resource activation 710, the UE 704 may configure, at 714, channel measurement resources for channel measurement associated with the indicated cells (e.g., 706b and 706c). In some aspects, configuring the channel measurement resources at 714 may include performing a prioritization operation over the at least one subset of resources of the set of resources for channel measurement and a set of resources for channel measurement of a network node of an active cell (e.g., PCell 702) to ensure that the at least one subset of resources of the set of resources for channel measurement and the set of resources for channel measurement of the network node of the active cell includes no more than a maximum number of resources. The maximum number of resources allowed to be used for channel measurement, in some aspects, may be based on a capability reported by the wireless device.

At 718, the UE 704 may then, based on the channel measurement resource activation 710 and the configuration at 714, measure and/or obtain channel state information based on a set of transmissions 716 from the set of deactivated cells associated with channel measurement. The measured set of transmissions may include a subset of the transmissions indicated in the channel measurement resource activation 710 (e.g., transmission 716b and transmission 716c but not transmission 716a) from the full set of transmissions 716 that are indicated in the channel measurement resource configuration 708. Based on the configured channel measurement resources, the UE 704 may obtain, at 718, CSI associated with the at least one deactivated cell (e.g., cell 706b and cell 706c). For example, by measuring resources in the subsets of resources 707b and 707c associated with cells 706b and 706c, respectively, the UE 704 may obtain CSI for cells 706b and 706c.

Based on the CSI measured and/or obtained at 718, the UE may transmit and the PCell 702 may receive, CSI indication 720 (e.g., a CSI report). The CSI indication 720, in some aspects, may include CSI for each deactivated cell for which CSI was measured and/or obtained. The CSI for each deactivated cell included in the CSI indication 720, in some aspects, may be associated with a cell identifier for the corresponding deactivated cell. At handover initiation 722, a handover may be initiated based on a movement of the UE 704 or some other factor (e.g., increased relative performance of a candidate (e.g., an SCell or PSCell) cell in relation to the PCell 702). The PCell 702 (or a network entity connected to the PCell 702), in some aspects, may then update, at 724, a candidate cell configuration designation. The update at 724, in some aspects, may be performed based on the CSI indication 720 in the absence of a handover initiation 722 and may be based on the information included in the CSI indication 720 (e.g., a configuration indicating a selected beam for a PSCell or PCell may be updated pre-emptively based on the information in the CSI indication 720). The update, in some aspects, may be based on a set of transmissions between the PCell 702 and a measured cell 706b (e.g., a PSCell transitioning to be a PCell) including a handover indication 724A and/or a reconfiguration information 724B. In some aspects, the PCell 702 may transmit, and the UE 704 may receive, an updated candidate cell configuration indication 726. The updated candidate cell configuration indication 726, in some aspects, may include information regarding a beam to use to communicate with a newly selected PCell (e.g., cell 706b). In some aspects, the updated candidate cell configuration indication 726 may include one of a same set of cells with an updated set of designations (e.g., PCell, SpCell, PSCells, or SCells) or a different set of cells with an updated and/or new set of designations. The UE 704 and the cell 706b (e.g., the newly designated PCell) may exchange communication 728 based on the updated candidate cell configuration indication 726 and the cell 706b may perform a similar set of operations to those described in relation to FIG. 7 based on the updated candidate cell configuration indication 726.

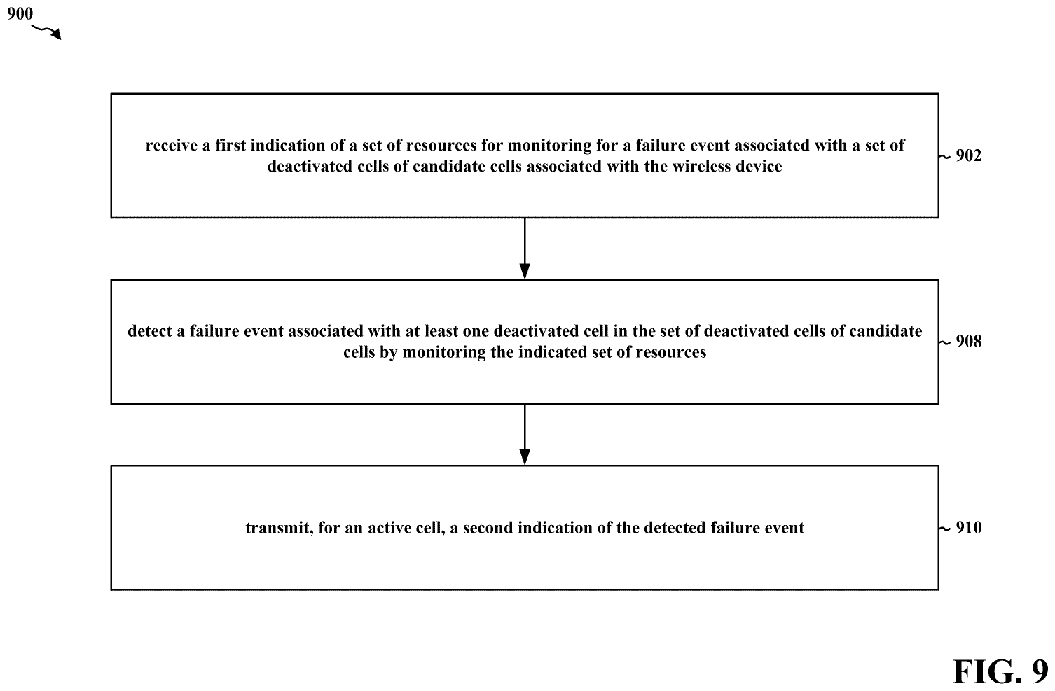

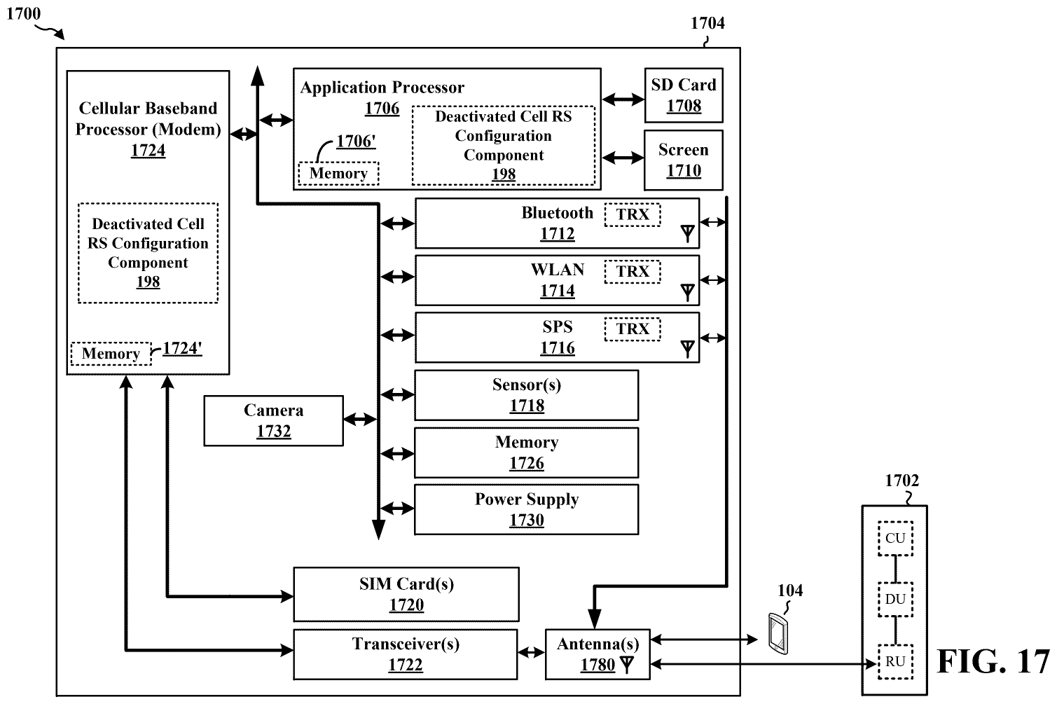

FIG. 9 is a flowchart 900 of a method of wireless communication. The method may be performed by a UE as an example of a wireless device (e.g., the UE 104, 404, 504, 604, and 704; the apparatus 1704). At 902, the UE may receive a first indication of a set of resources for monitoring for a failure event associated with a corresponding set of deactivated cells of candidate cells associated with the wireless device for L1/L2 mobility. For example, 902 may be performed by application processor 1706, cellular baseband processor 1724, transceiver(s) 1722, antenna(s) 1780, and/or deactivated cell RS configuration component 198 of FIG. 17. In some aspects, the set of resources may include reference signal resources for the set of deactivated cells. The first indication of the set of resources, in some aspects, may be based on a set of CORESETs for a corresponding set of CORESET pool indexes associated with at least one deactivated cell of a candidate cell. In some aspects, the set of resources is periodic and has a same quasi co-location (QCL) assumption as the CORESET. For example, referring to FIG. 6, UE 604 may receive, and PCell 602 may transmit, failure detection resource configuration 608 indicating a set of resources 607 for monitoring for a failure event associated with a corresponding set of deactivated network nodes of candidate cells (e.g., cells 606a-606c) associated with the UE 604. The failure detection resource configuration 608, in some aspects, may be one of (1) transmitted/received via a RRC signal, (2) known, or (3) an update to a previously-received indication of a different set of resources transmitted/received via a MAC-CE.

The indication of the set of resources, in some aspects, may include an indication of a plurality of subsets of resources. In some aspects, each subset of resources may be associated with a particular deactivated cell in the set of deactivated cells. For example, the subset of resources 607a may be associated with cell 606a, the subset of resources 607b may be associated with cell 606b, and the subset of resources 607c may be associated with cell 606c. In some aspects, at least two of the plurality of subsets of resources are associated with different TRPs of a same deactivated cell. For example, failure detection resource configuration 608 (e.g., the indication of the set of resources) may include at least two subsets of resources associated with different TRPs of a same deactivated network node (e.g., if any two of cells 606a-606c represent different TRPs of a same deactivated network node/cell).

Based on the indication of the set of resources for monitoring for the failure event, the UE may receive an activation indication activating at least one subset of resources of the set of resources for monitoring for the failure event. In some aspects, the activation indication may be transmitted/received via one of (1) a MAC-CE or (2) DCI. The activation indication, in some aspects, may activate at least one subset of resources of the set of resources for monitoring for the failure event. In some aspects, a timing between receiving the activation indication and activating the at least one subset of resources occurs is based on one of a fixed timing offset or a configurable timing offset indicated in the activation indication (e.g., based on a number of slots, symbols, or milliseconds). For example, referring to FIG. 6, the UE 604 may receive, and the PCell 602 may transmit, the failure detection resource activation 610. The failure detection resource activation 610 may indicate for the UE 604 to activate the subsets of resources 607b and 607c associated with deactivated cells 606b and 606c, respectively.

The UE may monitor the at least one subset of resources of the set of resources for monitoring for the failure event. The monitoring may be over the resources indicated in the activation indication (e.g., an indication of one or more subsets of resources indicated in the indication of the set of resources received at 902). In some aspects, the monitored resources may be based on the activation indication and a prioritization operation over the at least one subset of resources of the set of resources for monitoring for the failure event and a set of resources for monitoring for a failure of one or more active cells (e.g., a PCell or active SCell or PSCell) to ensure that the at least one subset of resources of the set of resources for monitoring for the failure event and the set of resources for monitoring for the failure of the one or more active cells include no more than a maximum number of resources based on a capability reported by the wireless device. For example, referring to FIG. 6, the UE 604, at 616, may monitor a set of transmissions 614 from the set of deactivated cells associated with the beam and/or radio link failure detection based on the failure detection resource activation 610 and the configuration at 612. The monitored set of transmissions may include a subset of the transmissions indicated in the failure detection resource activation 610 (e.g., transmission 614b and transmission 614c but not transmission 614a) from the full set of transmissions 614 that are indicated in the failure detection resource configuration 608.

At 908, the UE may detect a failure event associated with a beam of at least one deactivated cell in the set of deactivated cells of candidate cells by monitoring the indicated set of resources. For example, 908 may be performed by application processor 1706, cellular baseband processor 1724, and/or deactivated cell RS configuration component 198 of FIG. 17. In some aspects, the detection at 908 may be based on the monitoring at 906. For example, referring to FIG. 6, the UE 604 may detect a failure event at 616 associated with a beam of at least one deactivated cell (e.g., cell 606b). For example, by monitoring resources in the subset of resources 607b associated with cell 606b, the UE 604 may determine that transmission 614b indicates a failure of a beam or radio link between the UE 604 and the cell 606b (e.g., based on a failure to receive the transmission 614b from cell 606b).

Finally, at 910, the UE may transmit, for an active cell, a second indication of the detected failure event. For example, 910 may be performed by application processor 1706, cellular baseband processor 1724, transceiver(s) 1722, antenna(s) 1780, and/or deactivated cell RS configuration component 198 of FIG. 17. The indication of the detected failure event, in some aspects, may include an identification of the deactivated cell associated with the failure event and/or additional information for updating a MCG or a SCG. For example, referring to FIG. 6, the UE 604 may transmit, and the PCell 602 may receive, failure detection indication 618.

Based on the indication of the detected failure event transmitted at 910, the UE may receive a third indication of updated configuration of deactivated cells of the candidate cells. The updated configuration of deactivated cells of the candidate cells, in some aspects, may include one of a same set of cells with an updated set of designations (e.g., PSCells or SCells) or a different set of cells. The update, in some aspects, may be based on a set of transmissions between the active cell (e.g., a PCell) to which the indication of the detected failure event was transmitted and a failed cell (e.g., a PSCell). The set of transmissions between the active cell and the failed cell, in some aspects, may include a failure indication transmitted by the active cell, and received by the failed cell, and/or reconfiguration information transmitted by the failed cell and received by the active cell. For example, referring to FIG. 6, the UE 604 may receive updated cell group configuration indication 622, where, in some aspects, the update may be based on the set of transmissions between the PCell 602 and a failed cell 606b (e.g., a PSCell) including a failure indication 620A and/or a reconfiguration information 620B.

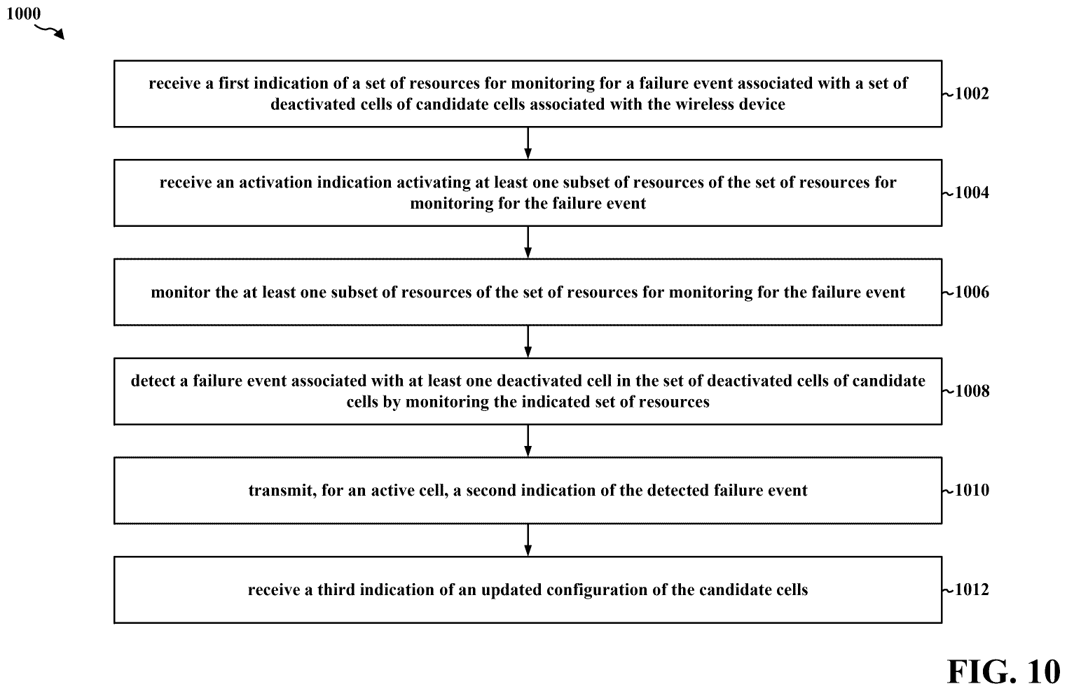

FIG. 10 is a flowchart 1000 of a method of wireless communication. The method may be performed by a UE as an example of a wireless device (e.g., the UE 104, 404, 504, 604, and 704; the apparatus 1704). At 1002, the UE may receive a first indication of a set of resources for monitoring for a failure event associated with a corresponding set of deactivated cells of candidate cells associated with the wireless device for L1/L2 mobility. For example, 1002 may be performed by application processor 1706, cellular baseband processor 1724, transceiver(s) 1722, antenna(s) 1780, and/or deactivated cell RS configuration component 198 of FIG. 17. In some aspects, the set of resources may include reference signal resources for the set of deactivated cells. The indication of the set of resources, in some aspects, may be based on a set of CORESETs for a corresponding set of CORESET pool indexes associated with at least one deactivated cell of a candidate cell. In some aspects, the set of resources is periodic and has a same QCL assumption as the CORESET. For example, referring to FIG. 6, UE 604 may receive, and PCell 602 may transmit, failure detection resource configuration 608 indicating a set of resources 607 for monitoring for a failure event associated with a corresponding set of deactivated cells of candidate cells (e.g., cells 606a-606c) associated with the UE 604. The failure detection resource configuration 608, in some aspects, may be one of (1) transmitted/received via a RRC signal, (2) known, or (3) an update to a previously-received indication of a different set of resources transmitted/received via a MAC-CE.

The indication of the set of resources, in some aspects, may include an indication of a plurality of subsets of resources. In some aspects, each subset of resources may be associated with a particular deactivated cell in the set of deactivated cells. For example, the subset of resources 607a may be associated with cell 606a, the subset of resources 607b may be associated with cell 606b, and the subset of resources 607c may be associated with cell 606c. In some aspects, at least two of the plurality of subsets of resources are associated with different TRPs of a same deactivated cell. For example, failure detection resource configuration 608 (e.g., the indication of the set of resources) may include at least two subsets of resources associated with different TRPs of a same deactivated cell (e.g., if any two of cells 606a-606c represent different TRPs of a same deactivated network node/cell).

At 1004, the UE may receive an activation indication activating at least one subset of resources of the set of resources for monitoring for the failure event. For example, 1004 may be performed by application processor 1706, cellular baseband processor 1724, transceiver(s) 1722, antenna(s) 1780, and/or deactivated cell RS configuration component 198 of FIG. 17. In some aspects, the activation indication may be transmitted/received via one of (1) a MAC-CE or (2) DCI. The activation indication, in some aspects, may activate at least one subset of resources of the set of resources for monitoring for the failure event. In some aspects, a timing between receiving the activation indication and activating the at least one subset of resources occurs is based on one of a fixed timing offset or a configurable timing offset indicated in the activation indication (e.g., based on a number of slots, symbols, or milliseconds). For example, referring to FIG. 6, the UE 604 may receive, and the PCell 602 may transmit, the failure detection resource activation 610. The failure detection resource activation 610 may indicate for the UE 604 to activate the subsets of resources 607b and 607c associated with deactivated cells 606b and 606c, respectively.

At 1006, the UE may monitor the at least one subset of resources of the set of resources for monitoring for the failure event. For example, 1006 may be performed by application processor 1706, cellular baseband processor 1724, and/or deactivated cell RS configuration component 198 of FIG. 17. The monitoring, at 1006, may be over the resources indicated in the activation indication received at 1004. In some aspects, the resources monitored at 1006 may be based on the activation indication and a prioritization operation over the at least one subset of resources of the set of resources for monitoring for the failure event and a set of resources for monitoring for a failure of one or more active cells (e.g., a PCell or active SCell or PSCell) to ensure that the at least one subset of resources of the set of resources for monitoring for the failure event and the set of resources for monitoring for the failure of the one or more active cells include no more than a maximum number of resources based on a capability reported by the wireless device. For example, referring to FIG. 6, the UE 604, at 616, may monitor a set of transmissions 614 from the set of deactivated cells associated with the beam and/or radio link failure detection based on the failure detection resource activation 610 and the configuration at 612. The monitored set of transmissions may include a subset of the transmissions indicated in the failure detection resource activation 610 (e.g., transmission 614b and transmission 614c but not transmission 614a) from the full set of transmissions 614 that are indicated in the failure detection resource configuration 608.

At 1008, the UE may detect a failure event associated with a beam of at least one deactivated cell in the set of deactivated cells of candidate cells by monitoring the indicated set of resources. For example, 1008 may be performed by application processor 1706, cellular baseband processor 1724, and/or deactivated cell RS configuration component 198 of FIG. 17. In some aspects, the detection at 1008 may be based on the monitoring at 1006. For example, referring to FIG. 6, the UE 604 may detect a failure event at 616 associated with at least one deactivated cell (e.g., cell 606b). For example, by monitoring resources in the subset of resources 607b associated with cell 606b, the UE 604 may determine that transmission 614b indicates a failure of a beam or radio link between the UE 604 and the cell 606b (e.g., based on a failure to receive the transmission 614b from cell 606b).

At 1010, the UE may transmit, for an active cell, an indication of the detected failure event. For example, 1010 may be performed by application processor 1706, cellular baseband processor 1724, transceiver(s) 1722, antenna(s) 1780, and/or deactivated cell RS configuration component 198 of FIG. 17. The indication of the detected failure event, in some aspects, may include an identification of the deactivated cell (and the beam) associated with the failure event and/or additional information for updating a MCG or a SCG. For example, referring to FIG. 6, the UE 604 may transmit, and the PCell 602 may receive, failure detection indication 618.

Finally, at 1012, the UE may receive a third indication of an updated configuration of the candidate cells. For example, 1012 may be performed by application processor 1706, cellular baseband processor 1724, transceiver(s) 1722, antenna(s) 1780, and/or deactivated cell RS configuration component 198 of FIG. 17. The updated configuration, in some aspects, may include one or more of an update to the candidate cells, an update to the designation (e.g., as SCell, PSCell, etc.) of one or more candidate cells, or a configuration of a deactivated cell of the candidate cells. The update, in some aspects, may be based on a set of transmissions between the base station (e.g., the active cell or PCell) and a failed cell (e.g., a PSCell). The set of transmissions between the network node of the base station and the failed cell, in some aspects, may include a failure indication transmitted by the network node of the active cell, and received by the failed cell, and/or reconfiguration information transmitted by the failed cell and received by the network node of the active cell. For example, referring to FIG. 6, the PCell 602 may update the configuration of the candidate cells at 620 based on the failure indication 620A and/or the reconfiguration information 620B. For example, referring to FIG. 6, the UE 604 may receive updated cell group configuration indication 622, where, in some aspects, the update may be based on the set of transmissions between the PCell 602 and a failed cell 606b (e.g., a PSCell) including a failure indication 620A and/or a reconfiguration information 620B.

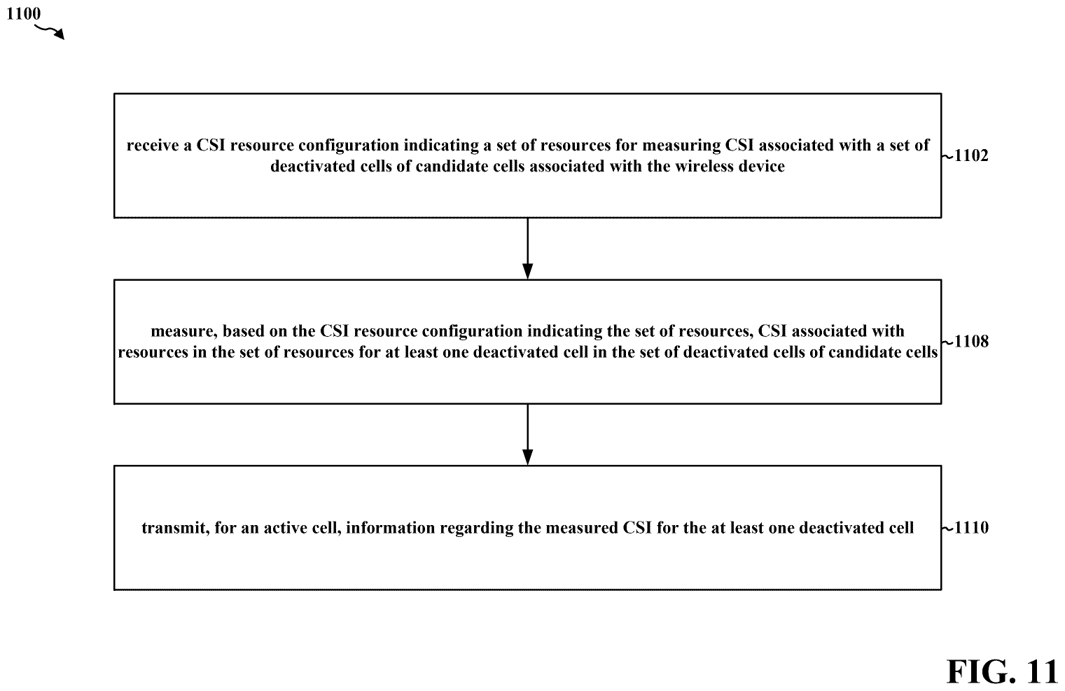

FIG. 11 is a flowchart 1100 of a method of wireless communication. The method may be performed by a UE as an example of a wireless device (e.g., the UE 104, 404, 504, 604, and 704; the apparatus 1704). At 1102, the UE may receive a CSI resource configuration indicating a first set of resources for measuring CSI associated with a corresponding set of deactivated candidate cells associated with the wireless device for L1/L2 mobility. For example, 1102 may be performed by application processor 1706, cellular baseband processor 1724, transceiver(s) 1722, antenna(s) 1780, and/or deactivated cell RS configuration component 198 of FIG. 17. In some aspects, the first set of resources may include at least one of channel measurement resources or interference measurement resources. The indication of the first set of resources, in some aspects, may be based on a set of CORESETs for a corresponding set of CORESET pool indexes associated with at least one deactivated cell of a candidate cell. In some aspects, the set of resources is periodic and has a same QCL assumption as the CORESET. For example, referring to FIG. 7, UE 704 may receive, and PCell 702 may transmit, channel measurement resource configuration 708 indicating a set of resources 707 for channel measurement for a corresponding set of deactivated cells of candidate cells (e.g., cells 706a-706c) associated with the UE 704. The channel measurement resource configuration 708, in some aspects, may be one of (1) transmitted/received via a RRC signal, (2) known, or (3) an update to a previously-received indication of a different set of resources transmitted/received via a MAC-CE.

The indication of the first set of resources, in some aspects, may include an indication of a plurality of subsets of resources. In some aspects, each subset of resources may be associated with a particular deactivated cell in the set of deactivated cells. For example, the subset of resources 707a may be associated with cell 706a, the subset of resources 707b may be associated with cell 706b, and the subset of resources 707c may be associated with cell 706c. In some aspects, at least two of the plurality of subsets of resources are associated with different TRPs of a same deactivated cell. For example, channel measurement resource configuration 708 (e.g., the indication of the set of resources) may include at least two subsets of resources associated with different TRPs of a same deactivated cell (e.g., if any two of cells 706a-706c represent different TRPs of a same deactivated network node/cell).

In some aspects, the UE may receive a CSI report configuration indicating a second set of resources for reporting CSI information associated with the corresponding set of deactivated cells to an active cell. For example, 1106 may be performed by application processor 1706, cellular baseband processor 1724, transceiver(s) 1722, antenna(s) 1780, and/or deactivated cell RS configuration component 198 of FIG. 17. The CSI report configuration, in some aspects, may indicate one of a set of periodic resources, a set of semi-persistent resources, or a set of aperiodic resources for transmitting the information regarding the measured CSI for the at least one deactivated cell. The CSI report configuration may include a modified CSI-ReportConfig IE. The CSI-ReportConfig IE may include a field (e.g., a “carrier” field) that, in some aspects, may include a cell index associated with one or more (non-PCell) deactivated and/or candidate cells that are associated with a wireless device. In some aspects, the CSI report configuration may indicate a set of semi-persistent resources associated with a PUCCH and the CSI report configuration may be received via a MAC-CE associated with an active cell. The CSI report configuration, in some aspects, may indicate one of a set of semi-persistent resources associated with a PUSCH or a set of aperiodic resources associated with the PUSCH and the CSI report configuration may be received via DCI (e.g., a DCI scrambled by SP-CSI-C-RNTI for SP resources or a DCI scrambled by C-RNTI for AP resources) associated with an active cell. For example, referring to FIGS. 7 and 8, the UE 704 may receive, and the PCell 702 may transmit, the CSI report configuration indication 705 that may include a CSI-ReportConfig IE 801. As discussed above in relation to FIG. 7, receiving the CSI resource configuration at #1102 may be based on receiving the CSI resource configuration included or indicated in the CSI report configuration (e.g., a CSI-ReportConfig IE).

The UE, in some aspects, may receive an activation indication activating at least one subset of resources of the first set of resources for measuring CSI. In some aspects, the activation indication may be transmitted/received via one of (1) a MAC-CE or (2) DCI. For example, for periodic or SP CSI resources, the activation indication, in some aspects may be transmitted/received via a MAC-CE or DCI (e.g., a DCI scrambled by SP-CSI-C-RNTI for SP resources) on any active cell for activating the periodic or SP CSI resources. In some aspects, for AP CSI resources, the activation indication may be transmitted/received via DCI (e.g., a DCI scrambled by C-RNTI) on any active cell for activating the AP CSI resources. The activation indication, in some aspects, may activate at least one subset of resources of the set of resources for channel (e.g., CSI) measurement. For example, referring to FIG. 7, the UE 704 may receive, and the PCell 702 may transmit, the channel measurement resource activation 710 indicating for the UE 704 to activate the subsets of resources 707b and 707c associated with deactivated cells 706b and 706c, respectively. In some aspects, a timing between receiving the activation indication and activating the at least one subset of resources occurs may be based on a fixed timing offset (e.g., based on a number of slots, symbols, or milliseconds).

At 1108, the UE may measure (or obtain), based on the CSI resource configuration indicating the first set of resources, CSI associated with resources in the first set of resources for at least one deactivated cell in the set of deactivated candidate cells. For example, 1108 may be performed by application processor 1706, cellular baseband processor 1724, transceiver(s) 1722, antenna(s) 1780, and/or deactivated cell RS configuration component 198 of FIG. 17. The measured set of transmissions may include a subset of the transmissions (e.g., transmissions associated with the resources identified in the activation indication received at 1104) from the full set of transmissions that are indicated in the CSI resource configuration received at 1102. For example, referring to FIG. 7, the UE 704 may obtain, at 718, CSI associated with the at least one deactivated cell (e.g., cell 706b and cell 706c) indicated in the channel measurement resource activation 710. The UE 704, for example, may measure resources in the subsets of resources 707b and 707c associated with cells 706b and 706c, respectively, to obtain CSI for cells 706b and 706c.

At 1110, the UE may transmit, for an active cell, information regarding the measured CSI for the at least one deactivated cell. For example, 1110 may be performed by application processor 1706, cellular baseband processor 1724, transceiver(s) 1722, antenna(s) 1780, and/or deactivated cell RS configuration component 198 of FIG. 17. The information regarding the measured CSI for the at least one deactivated cell, in some aspects, may include CSI for each deactivated cell for which CSI was measured and/or obtained. For example, referring to FIG. 7, the UE 704 may transmit, and the PCell 702 may receive, CSI indication 720.

The UE may receive an indication of an updated configuration of the candidate cells. The updated configuration, in some aspects, may include one or more of an update to the candidate cells, an update to the designation (e.g., as PCell, SpCell, SCell, PSCell, etc.) of one or more candidate cells, or a configuration of a deactivated cell of the candidate cells. For example, the updated configuration may include a configuration related to a beam for communication with a particular deactivated cell. The update, in some aspects, may be based on a set of transmissions between the active cell (e.g., a PCell) and a deactivated cell (e.g., a PSCell). The update, in some aspects, may be based on a set of transmissions between the active cell and a measured (deactivated) cell (e.g., a PSCell transitioning to be a PCell) including a handover indication and/or a reconfiguration information. For example, referring to FIG. 7, the UE 704 may receive, and the PCell 702 may transmit, the updated candidate cell configuration indication 726. The updated candidate cell configuration indication 726, in some aspects, may be based on (1) a handover initiation 722 that may be initiated based on a movement of the UE 704 or some other factor (e.g., increased relative performance of a candidate (e.g., an SCell or PSCell) cell in relation to the PCell 702) and (2) the set of transmissions between the PCell 702 and a measured cell 706b (e.g., a PSCell transitioning to be a PCell) including a handover indication 724A and/or a reconfiguration information 724B.

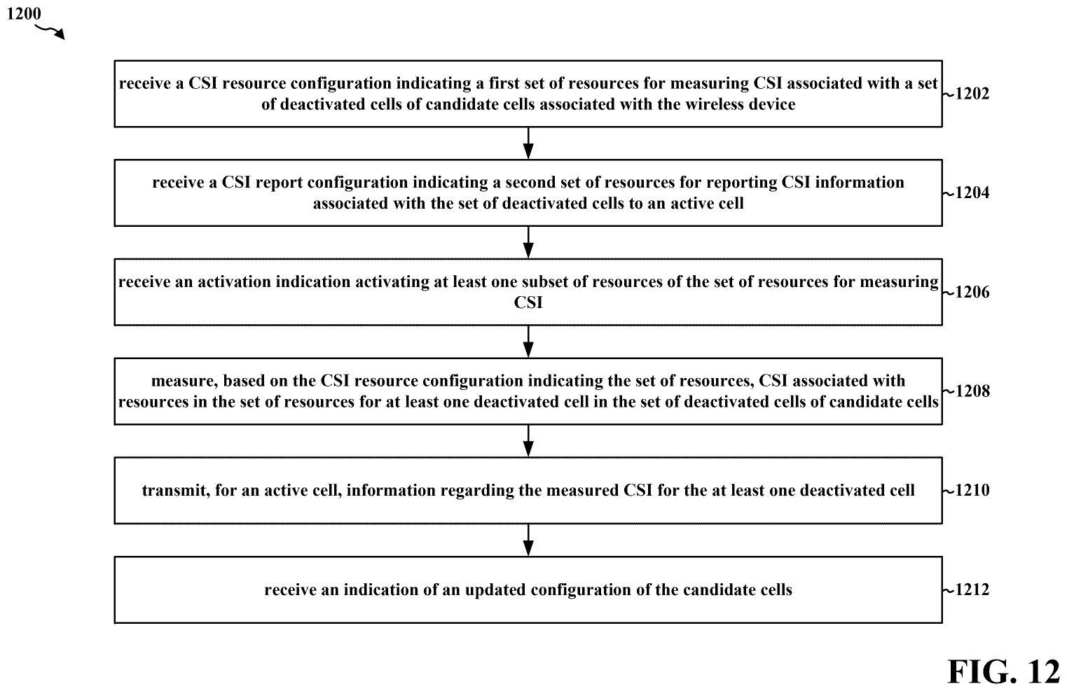

FIG. 12 is a flowchart 1200 of a method of wireless communication. The method may be performed by a UE as an example of a wireless device (e.g., the UE 104, 404, 504, 604, and 704; the apparatus 1704). At 1202, the UE may receive a CSI resource configuration indicating a first set of resources for measuring CSI associated with a corresponding set of deactivated candidate cells associated with the wireless device for L1/L2 mobility. For example, 1202 may be performed by application processor 1706, cellular baseband processor 1724, transceiver(s) 1722, antenna(s) 1780, and/or deactivated cell RS configuration component 198 of FIG. 17. In some aspects, the first set of resources may include at least one of channel measurement resources or interference measurement resources. The indication of the first set of resources, in some aspects, may be based on a set of CORESETs for a corresponding set of CORESET pool indexes associated with at least one deactivated cell of a candidate cell. In some aspects, the set of resources is periodic and has a same QCL assumption as the CORESET. For example, referring to FIG. 7, UE 704 may receive, and PCell 702 may transmit, channel measurement resource configuration 708 indicating a set of resources 707 for channel measurement for a corresponding set of deactivated cells of candidate cells (e.g., cells 706a-706c) associated with the UE 704. The channel measurement resource configuration 708, in some aspects, may be one of (1) transmitted/received via a RRC signal, (2) known, or (3) an update to a previously-received indication of a different set of resources transmitted/received via a MAC-CE.

The indication of the first set of resources, in some aspects, may include an indication of a plurality of subsets of resources. In some aspects, each subset of resources may be associated with a particular deactivated cell in the set of deactivated cells. For example, the subset of resources 707a may be associated with cell 706a, the subset of resources 707b may be associated with cell 706b, and the subset of resources 707c may be associated with cell 706c. In some aspects, at least two of the plurality of subsets of resources are associated with different TRPs of a same deactivated cell. For example, channel measurement resource configuration 708 (e.g., the indication of the set of resources) may include at least two subsets of resources associated with different TRPs of a same deactivated cell (e.g., if any two of cells 706a-706c represent different TRPs of a same deactivated network node/cell).

At 1204, the UE may receive a CSI report configuration indicating a second set of resources for reporting CSI information associated with the corresponding set of deactivated cells to an active cell. For example, 1204 may be performed by application processor 1706, cellular baseband processor 1724, transceiver(s) 1722, antenna(s) 1780, and/or deactivated cell RS configuration component 198 of FIG. 17. The CSI report configuration, in some aspects, may indicate one of a set of periodic resources, a set of semi-persistent resources, or a set of aperiodic resources for transmitting the information regarding the measured CSI for the at least one deactivated cell. The CSI report configuration may include a modified CSI-ReportConfig IE. The CSI-ReportConfig IE may include a field (e.g., a “carrier” field) that, in some aspects, may include a cell index associated with one or more (non-PCell) deactivated and/or candidate cells that are associated with a wireless device. In some aspects, the CSI report configuration may indicate a set of semi-persistent resources associated with a PUCCH and the CSI report configuration may be received via a MAC-CE associated with an active cell. The CSI report configuration, in some aspects, may indicate one of a set of semi-persistent resources associated with a PUSCH or a set of aperiodic resources associated with the PUSCH and the CSI report configuration may be received via DCI (e.g., a DCI scrambled by SP-CSI-C-RNTI for SP resources or a DCI scrambled by C-RNTI for AP resources) associated with an active cell. For example, referring to FIGS. 7 and 8, the UE 704 may receive, and the PCell 702 may transmit, the CSI report configuration indication 705 that may include a CSI-ReportConfig IE 801. As discussed above in relation to FIG. 7, receiving the CSI resource configuration at #1202 may be based on receiving the CSI resource configuration included or indicated in the CSI report configuration (e.g., a CSI-ReportConfig IE).

At 1206, the UE may receive an activation indication activating at least one subset of resources of the first set of resources for measuring CSI. For example, 1206 may be performed by application processor 1706, cellular baseband processor 1724, transceiver(s) 1722, antenna(s) 1780, and/or deactivated cell RS configuration component 198 of FIG. 17. In some aspects, the activation indication may be transmitted/received via one of (1) a MAC-CE or (2) DCI. For example, for periodic or SP CSI resources, the activation indication, in some aspects may be transmitted/received via a MAC-CE or DCI (e.g., a DCI scrambled by SP-CSI-C-RNTI for SP resources) on any active cell for activating the periodic or SP CSI resources. In some aspects, for AP CSI resources, the activation indication may be transmitted/received via DCI (e.g., a DCI scrambled by C-RNTI) on any active cell for activating the AP CSI resources. The activation indication, in some aspects, may activate at least one subset of resources of the set of resources for channel (e.g., CSI) measurement. For example, referring to FIG. 7, the UE 704 may receive, and the PCell 702 may transmit, the channel measurement resource activation 710 indicating for the UE 704 to activate the subsets of resources 707b and 707c associated with deactivated cells 706b and 706c, respectively. In some aspects, a timing between receiving the activation indication and activating the at least one subset of resources occurs may be based on a fixed timing offset (e.g., based on a number of slots, symbols, or milliseconds).

At 1208, the UE may measure (or obtain), based on the CSI resource configuration indicating the first set of resources, CSI associated with resources in the first set of resources for at least one deactivated cell in the set of deactivated candidate cells. For example, 1208 may be performed by application processor 1706, cellular baseband processor 1724, transceiver(s) 1722, antenna(s) 1780, and/or deactivated cell RS configuration component 198 of FIG. 17. The measured set of transmissions may include a subset of the transmissions (e.g., transmissions associated with the resources identified in the activation indication received ta 1204) from the full set of transmissions that are indicated in the CSI resource configuration received at 1202. For example, referring to FIG. 7, the UE 704 may obtain, at 718, CSI associated with the at least one deactivated cell (e.g., cell 706b and cell 706c) indicated in the channel measurement resource activation 710. The UE 704, for example, may measure resources in the subsets of resources 707b and 707c associated with cells 706b and 706c, respectively, to obtain CSI for cells 706b and 706c.

At 1210, the UE may transmit, for an active cell, information regarding the measured CSI for the at least one deactivated cell. For example, 1210 may be performed by application processor 1706, cellular baseband processor 1724, transceiver(s) 1722, antenna(s) 1780, and/or deactivated cell RS configuration component 198 of FIG. 17. The information regarding the measured CSI for the at least one deactivated cell, in some aspects, may include CSI for each deactivated cell for which CSI was measured and/or obtained. For example, referring to FIG. 7, the UE 704 may transmit, and the PCell 702 may receive, CSI indication 720.

Finally, at 1212, the UE may receive an indication of an updated configuration of the candidate cells. For example, 1212 may be performed by application processor 1706, cellular baseband processor 1724, transceiver(s) 1722, antenna(s) 1780, and/or deactivated cell RS configuration component 198 of FIG. 17. The updated configuration, in some aspects, may include one or more of an update to the candidate cells, an update to the designation (e.g., as PCell, SpCell, SCell, PSCell, etc.) of one or more candidate cells, or a configuration of a deactivated cell of the candidate cells. For example, the updated configuration may include a configuration related to a beam for communication with a particular deactivated cell. The update, in some aspects, may be based on a set of transmissions between the active cell (e.g., a PCell) and a deactivated cell (e.g., a PSCell). The update, in some aspects, may be based on a set of transmissions between the active cell and a measured (deactivated) cell (e.g., a PSCell transitioning to be a PCell) including a handover indication and/or a reconfiguration information. For example, referring to FIG. 7, the UE 704 may receive, and the PCell 702 may transmit, the updated candidate cell configuration indication 726. The updated candidate cell configuration indication 726, in some aspects, may be based on (1) a handover initiation 722 that may be initiated based on a movement of the UE 704 or some other factor (e.g., increased relative performance of a candidate (e.g., an SCell or PSCell) cell in relation to the PCell 702) and (2) the set of transmissions between the PCell 702 and a measured cell 706b (e.g., a PSCell transitioning to be a PCell) including a handover indication 724A and/or a reconfiguration information 724B.

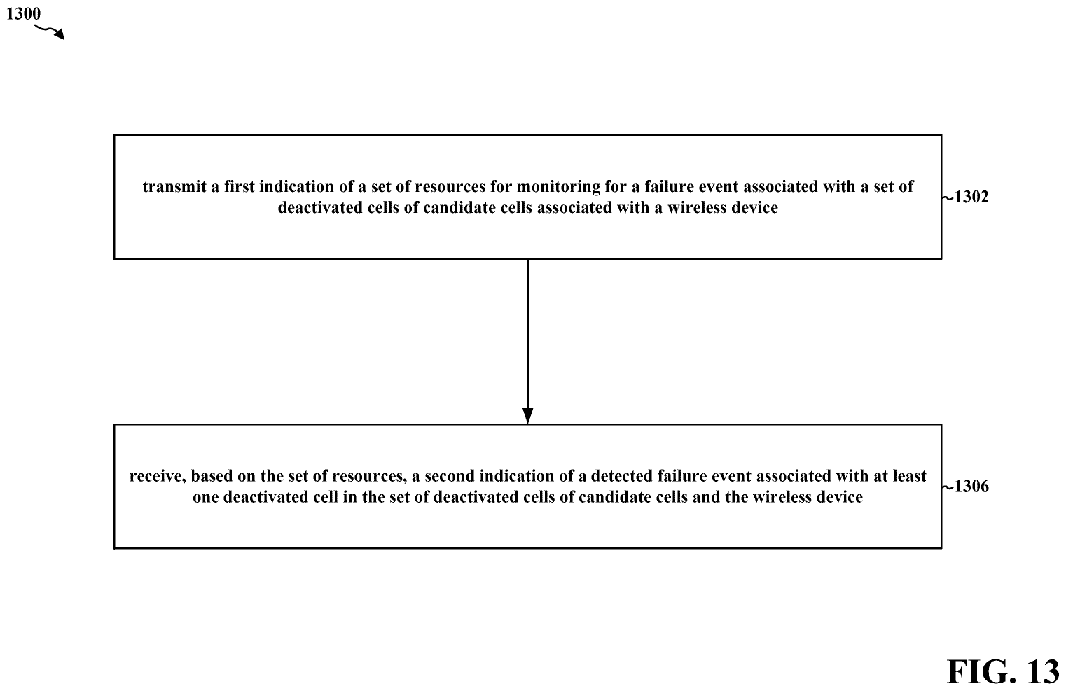

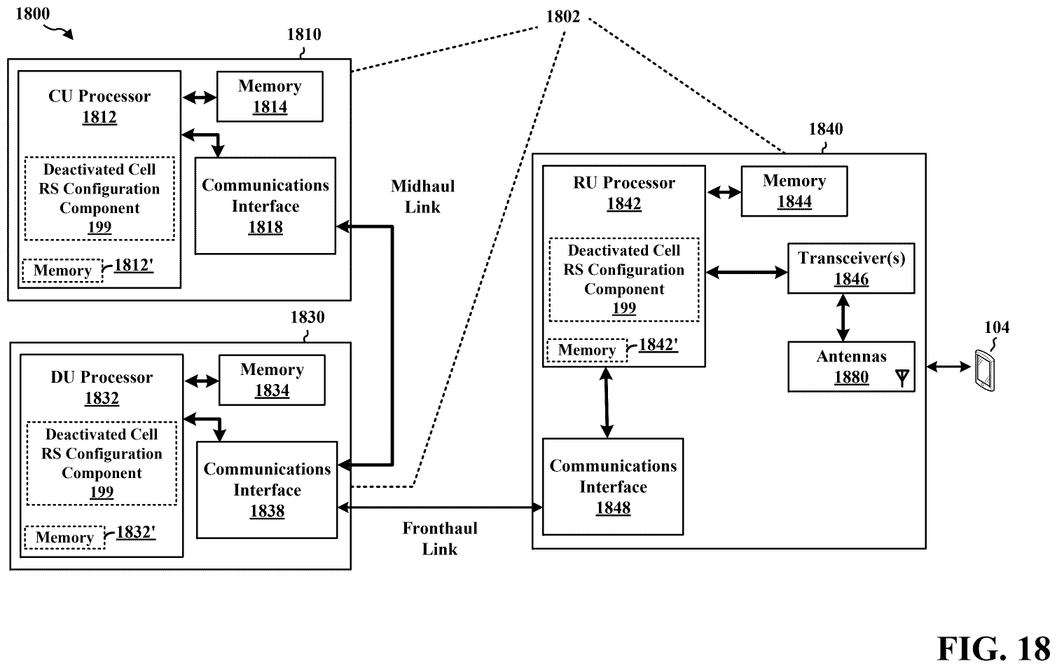

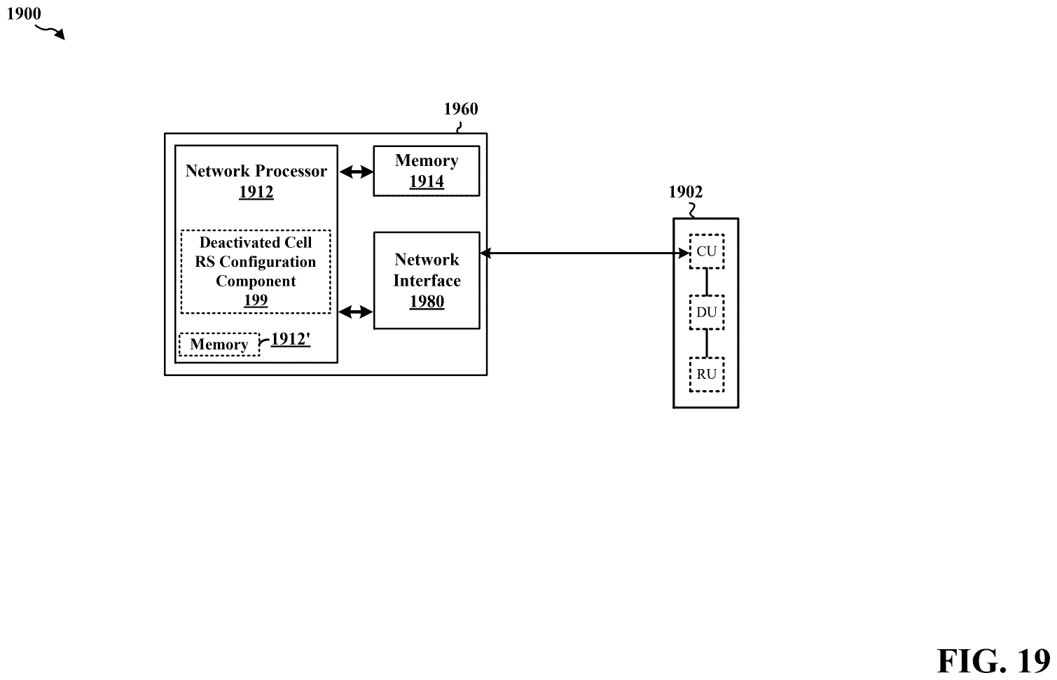

FIG. 13 is a flowchart 1300 of a method of wireless communication. The method may be performed by a base station as an example of an active cell (e.g., the base station 102; the SpCell 402, 502; the PCell 602, 702; the network entity 1802 or 1960). At 1302, the base station may transmit a first indication of a set of resources for monitoring for a failure event associated with a corresponding set of deactivated cells of candidate cells associated with the wireless device for L1/L2 mobility. For example, 1302 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. In some aspects, the set of resources may include reference signal resources for the set of deactivated cells. The indication of the set of resources, in some aspects, may be based on a set of CORESETs for a corresponding set of CORESET pool indexes associated with at least one deactivated cell of a candidate cell. In some aspects, the set of resources is periodic and has a same QCL assumption as the CORESET. For example, referring to FIG. 6, PCell 602 may transmit, and UE 604 may receive, failure detection resource configuration 608 indicating a set of resources 607 for monitoring for a failure event associated with a corresponding set of deactivated cells of candidate cells (e.g., cells 606a-c) associated with the PCell 602. The failure detection resource configuration 608, in some aspects, may be one of (1) transmitted/received via a RRC signal, (2) known, or (3) an update to a previously-received indication of a different set of resources transmitted/received via a MAC-CE.

The indication of the set of resources, in some aspects, may include an indication of a plurality of subsets of resources. In some aspects, each subset of resources may be associated with a particular deactivated cell in the set of deactivated cells. For example, the subset of resources 607a may be associated with cell 606a, the subset of resources 607b may be associated with cell 606b, and the subset of resources 607c may be associated with cell 606c. In some aspects, at least two of the plurality of subsets of resources are associated with different TRPs of a same deactivated cell. For example, failure detection resource configuration 608 (e.g., the indication of the set of resources) may include at least two subsets of resources associated with different TRPs of a same deactivated cell (e.g., if any two of cell 606a-606c represent different TRPs of a same deactivated cell).

The base station, in some aspects, may transmit an activation indication activating at least one subset of resources of the set of resources for monitoring for the failure event. In some aspects, the activation indication may be transmitted/received via one of (1) a MAC-CE or (2) DCI. The activation indication, in some aspects, may activate at least one subset of resources of the set of resources for monitoring for the failure event. In some aspects, a timing between receiving the activation indication and activating the at least one subset of resources occurs is based on one of a fixed timing offset or a configurable timing offset indicated in the activation indication (e.g., based on a number of slots, symbols, or milliseconds). For example, referring to FIG. 6, the PCell 602 may transmit, and the UE 604 may receive, the failure detection resource activation 610. The failure detection resource activation 610 may indicate for the PCell 602 to activate the subsets of resources 607b and 607c associated with deactivated cells 606b and 606c, respectively.

The UE may monitor the at least one subset of resources of the set of resources for monitoring for the failure event. The monitoring may be over the resources indicated in the activation indication. In some aspects, the monitored resources may be based on the activation indication and a prioritization operation over the at least one subset of resources of the set of resources for monitoring for the failure event and a set of resources for monitoring for a failure of a network node of one or more active cells (e.g., a PCell or active SCell or PSCell) to ensure that the at least one subset of resources of the set of resources for monitoring for the failure event and the set of resources for monitoring for the failure of the active cell(s) include no more than a maximum number of resources based on a capability reported by the wireless device. For example, referring to FIG. 6, the UE 604, at 616, may monitor a set of transmissions 614 from the set of deactivated cells associated with the beam and/or radio link failure detection based on the failure detection resource activation 610 and the configuration at 612. The monitored set of transmissions may include a subset of the transmissions indicated in the failure detection resource activation 610 (e.g., transmission 614b and transmission 614c but not transmission 614a) from the full set of transmissions 614 that are indicated in the failure detection resource configuration 608.

Based on the monitoring, the UE may detect a failure event associated with at least one deactivated cell in the set of deactivated cells of candidate cells by monitoring the indicated set of resources. For example, referring to FIG. 6, the PCell 602 may detect a failure event at 616 associated with at least one deactivated cell (e.g., cell 606b). For example, by monitoring resources in the subset of resources 607b associated with cell 606b, the PCell 602 may determine that transmission 614b indicates a failure of a beam or radio link between the PCell 602 and the cell 606b (e.g., based on a failure to receive the transmission 614b from cell 606b).

At 1306, the base station may receive, based on the set of resources (and the activation indication), a second indication of a detected failure event associated with a beam of at least one deactivated cell in the set of deactivated cells of the candidate cells and the wireless device. For example, 1306 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. The indication of the detected failure event, in some aspects, may include an identification of the deactivated cell associated with the failure event and/or additional information for updating a MCG or a SCG. For example, referring to FIG. 6, the PCell 602 may transmit, and the PCell 602 may receive, failure detection indication 618.

Based on the second indication, the base station may update a configuration of the candidate cells. The updated configuration, in some aspects, may include one or more of an update to the candidate cells, an update to the designation (e.g., as SCell, PSCell, etc.) of one or more candidate cells, or a configuration of a deactivated cell of the candidate cells. The update, in some aspects, may be based on a set of transmissions between the base station (e.g., the active cell or PCell) and a failed cell (e.g., a PSCell). The set of transmissions between the network node of the base station and the failed cell, in some aspects, may include a failure indication transmitted by the network node of the active cell, and received by the failed cell, and/or reconfiguration information transmitted by the failed cell and received by the network node of the active cell. For example, referring to FIG. 6, the PCell 602 may update the configuration of the candidate cells at 620 based on the failure indication 620A and/or the reconfiguration information 620B.

The base station may, in some aspects, transmit an indication of the updated configuration of the candidate cells. As discussed above, the updated configuration of the candidate cells, in some aspects, may include one of a same set of cells with an updated set of designations (e.g., PSCells or SCells) and/or configurations or a different set of cells. For example, referring to FIG. 6, the PCell 602 may transmit updated cell group configuration indication 622.

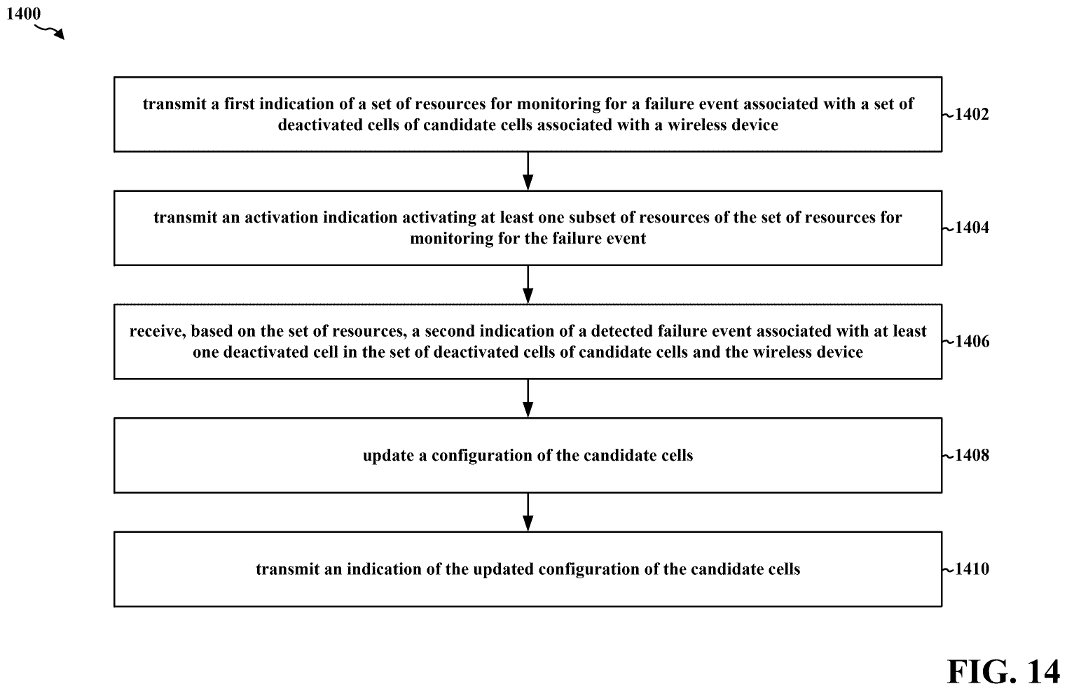

FIG. 14 is a flowchart 1400 of a method of wireless communication. The method may be performed by a base station as an example of an active cell (e.g., the base station 102; the SpCell 402, 502; the PCell 602, 702; the network entity 1802 or 1960). At 1402, the base station may transmit a first indication of a set of resources for monitoring for a failure event associated with a corresponding set of deactivated cells of candidate cells associated with the wireless device for L1/L2 mobility. For example, 1402 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. In some aspects, the set of resources may include reference signal resources for the set of deactivated cells. The indication of the set of resources, in some aspects, may be based on a set of CORESETs for a corresponding set of CORESET pool indexes associated with at least one deactivated cell of a candidate cell. In some aspects, the set of resources is periodic and QCL with a QCL assumption of the CORESET. For example, referring to FIG. 6, PCell 602 may transmit, and UE 604 may receive, failure detection resource configuration 608 indicating a set of resources 607 for monitoring for a failure event associated with a corresponding set of deactivated cells of candidate cells (e.g., cells 606a-c) associated with the PCell 602. The failure detection resource configuration 608, in some aspects, may be one of (1) transmitted/received via a RRC signal, (2) known, or (3) an update to a previously-received indication of a different set of resources transmitted/received via a MAC-CE.

The indication of the set of resources, in some aspects, may include an indication of a plurality of subsets of resources. In some aspects, each subset of resources may be associated with a particular deactivated cell in the set of deactivated cells. For example, the subset of resources 607a may be associated with cell 606a, the subset of resources 607b may be associated with cell 606b, and the subset of resources 607c may be associated with cell 606c. In some aspects, at least two of the plurality of subsets of resources are associated with different TRPs of a same deactivated cell. For example, failure detection resource configuration 608 (e.g., the indication of the set of resources) may include at least two subsets of resources associated with different TRPs of a same deactivated cell (e.g., if any two of cell 606a-606c represent different TRPs of a same deactivated cell).

At 1404, the base station may transmit an activation indication activating at least one subset of resources of the set of resources for monitoring for the failure event. For example, 1404 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. In some aspects, the activation indication may be transmitted/received via one of (1) a MAC-CE or (2) DCI. The activation indication, in some aspects, may activate at least one subset of resources of the set of resources for monitoring for the failure event. In some aspects, a timing between receiving the activation indication and activating the at least one subset of resources occurs is based on one of a fixed timing offset or a configurable timing offset indicated in the activation indication (e.g., based on a number of slots, symbols, or milliseconds). For example, referring to FIG. 6, the PCell 602 may transmit, and the UE 604 may receive, the failure detection resource activation 610. The failure detection resource activation 610 may indicate for the PCell 602 to activate the subsets of resources 607b and 607c associated with deactivated cells 606b and 606c, respectively.

The UE may monitor the at least one subset of resources of the set of resources for monitoring for the failure event. The monitoring may be over the resources indicated in the activation indication transmitted at 1404. In some aspects, the monitored resources may be based on the activation indication and a prioritization operation over the at least one subset of resources of the set of resources for monitoring for the failure event and a set of resources for monitoring for a failure of a network node of one or more active cells (e.g., a PCell or active SCell or PSCell) to ensure that the at least one subset of resources of the set of resources for monitoring for the failure event and the set of resources for monitoring for the failure of the active cell(s) include no more than a maximum number of resources based on a capability reported by the wireless device. For example, referring to FIG. 6, the UE 604, at 616, may monitor a set of transmissions 614 from the set of deactivated cells associated with the beam and/or radio link failure detection based on the failure detection resource activation 610 and the configuration at 612. The monitored set of transmissions may include a subset of the transmissions indicated in the failure detection resource activation 610 (e.g., transmission 614b and transmission 614c but not transmission 614a) from the full set of transmissions 614 that are indicated in the failure detection resource configuration 608.

Based on the monitoring, the UE may detect a failure event associated with at least one deactivated cell in the set of deactivated cells of candidate cells by monitoring the indicated set of resources. For example, referring to FIG. 6, the PCell 602 may detect a failure event at 616 associated with at least one deactivated cell (e.g., cell 606b). For example, by monitoring resources in the subset of resources 607b associated with cell 606b, the PCell 602 may determine that transmission 614b indicates a failure of a beam or radio link between the PCell 602 and the cell 606b (e.g., based on a failure to receive the transmission 614b from cell 606b).

At 1406, the base station may receive, based on the set of resources (and the activation indication), a second indication of a detected failure event associated with a beam of at least one deactivated cell in the set of deactivated cells of the candidate cells and the wireless device. For example, 1406 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. The indication of the detected failure event, in some aspects, may include an identification of the deactivated cell associated with the failure event and/or additional information for updating a MCG or a SCG. For example, referring to FIG. 6, the PCell 602 may transmit, and the PCell 602 may receive, failure detection indication 618.

At 1408, the base station may update a configuration of the candidate cells. For example, 1408 may be performed by CU processor 1812, DU processor 1832, RU processor 1842, network processor 1812, and/or deactivated cell RS configuration component 199 of FIGS. 18 and 19. The updated configuration, in some aspects, may include one or more of an update to the candidate cells, an update to the designation (e.g., as SCell, PSCell, etc.) of one or more candidate cells, or a configuration of a deactivated cell of the candidate cells. The update, in some aspects, may be based on a set of transmissions between the base station (e.g., the active cell or PCell) and a deactivated cell (e.g., a PSCell). The set of transmissions between the network node of the base station and the failed cell, in some aspects, may include a failure indication transmitted by the network node of the active cell, and received by the failed cell, and/or reconfiguration information transmitted by the failed cell and received by the network node of the active cell. For example, referring to FIG. 6, the PCell 602 may update the configuration of the candidate cells at 620 based on the failure indication 620A and/or the reconfiguration information 620B.

At 1410, the base station may transmit a third indication of the updated configuration of the candidate cells. For example, 1410 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. As discussed above, the updated configuration of the candidate cells, in some aspects, may include one of a same set of cells with an updated set of designations (e.g., PSCells or SCells) and/or configurations or a different set of cells. For example, referring to FIG. 6, the PCell 602 may transmit updated cell group configuration indication 622.

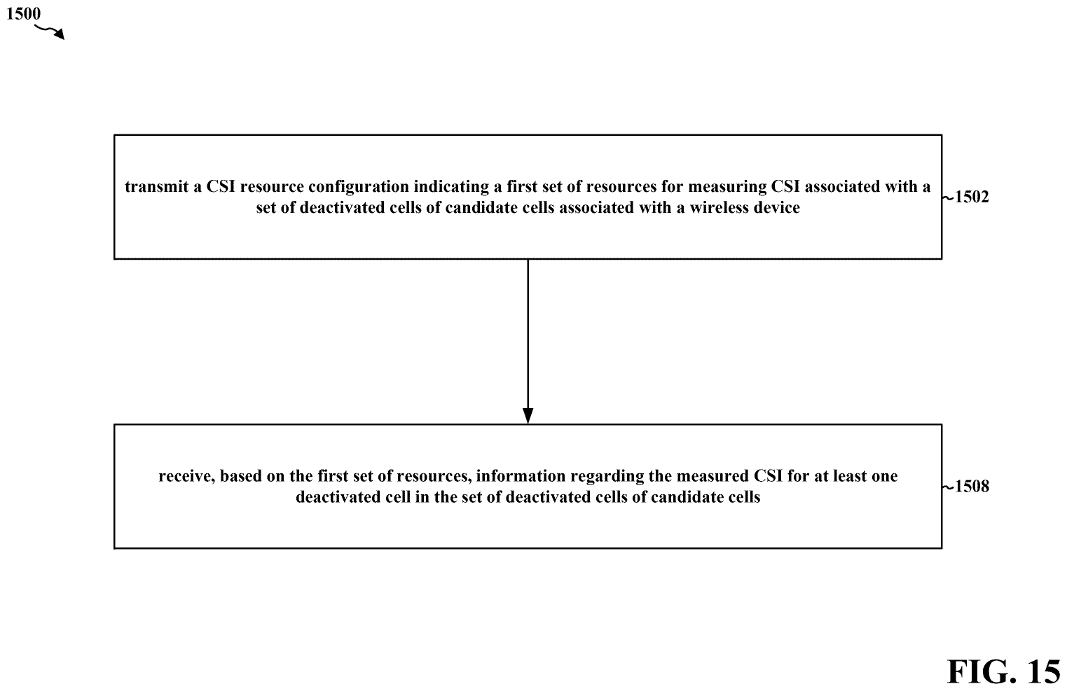

FIG. 15 is a flowchart 1500 of a method of wireless communication. The method may be performed by a base station as an example of an active cell (e.g., the base station 102; the SpCell 402, 502; the PCell 602, 702; the network entity 1802 or 1960). At 1502, the base station may transmit a CSI resource configuration indicating a first set of resources for measuring CSI associated with a corresponding set of deactivated candidate cells associated with the wireless device for L1/L2 mobility. For example, 1502 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. In some aspects, the first set of resources may include at least one of channel measurement resources or interference measurement resources. The indication of the first set of resources, in some aspects, may be based on a set of CORESETs for a corresponding set of CORESET pool indexes associated with at least one deactivated cell of a candidate cell. In some aspects, the set of resources is periodic and QCL with a QCL assumption of the CORESET. For example, referring to FIG. 7, PCell 702 may receive, and UE 704 may receive, channel measurement resource configuration 708 indicating a set of resources 707 for channel measurement for a corresponding set of deactivated cells of candidate cells (e.g., cells 706a-706c) associated with the UE 704. The channel measurement resource configuration 708, in some aspects, may be one of (1) transmitted/received via a RRC signal, (2) known, or (3) an update to a previously-received indication of a different set of resources transmitted/received via a MAC-CE.

The indication of the first set of resources, in some aspects, may include an indication of a plurality of subsets of resources. In some aspects, each subset of resources may be associated with a particular deactivated cell in the set of deactivated cells. For example, the subset of resources 707a may be associated with cell 706a, the subset of resources 707b may be associated with cell 706b, and the subset of resources 707c may be associated with cell 706c. In some aspects, at least two of the plurality of subsets of resources are associated with different TRPs of a same deactivated cell. For example, channel measurement resource configuration 708 (e.g., the indication of the set of resources) may include at least two subsets of resources associated with different TRPs of a same deactivated cell (e.g., if any two of cells 706a-706c represent different TRPs of a same deactivated network node/cell).

In some aspects, the base station may transmit a CSI report configuration indicating a second set of resources for reporting CSI information associated with the corresponding set of deactivated cells to an active cell. The CSI report configuration, in some aspects, may indicate one of a set of periodic resources, a set of semi-persistent resources, or a set of aperiodic resources for transmitting the information regarding the measured CSI for the at least one deactivated cell. The CSI report configuration may include a modified CSI-ReportConfig IE. The CSI-ReportConfig IE may include a field (e.g., a “carrier” field) that, in some aspects, may include a cell index associated with one or more (non-PCell) deactivated and/or candidate cells that are associated with a wireless device. In some aspects, the CSI report configuration may indicate a set of semi-persistent resources associated with a PUCCH and the CSI report configuration may be received via a MAC-CE associated with an active cell. The CSI report configuration, in some aspects, may indicate one of a set of semi-persistent resources associated with a PUSCH or a set of aperiodic resources associated with the PUSCH and the CSI report configuration may be received via DCI (e.g., a DCI scrambled by SP-CSI-C-RNTI for SP resources or a DCI scrambled by C-RNTI for AP resources) associated with an active cell. For example, referring to FIGS. 7 and 8, the PCell 702 may transmit, and the UE 704 may receive, the CSI report configuration indication 705 that may include a CSI-ReportConfig IE 801. As discussed above in relation to FIG. 7, receiving the CSI resource configuration at #1502 may be based on receiving the CSI resource configuration included or indicated in the CSI report configuration (e.g., a CSI-ReportConfig IE).

The base station, in some aspects, may transmit an activation indication activating at least one subset of resources of the first set of resources for measuring CSI. In some aspects, the activation indication may be transmitted/received via one of (1) a MAC-CE or (2) DCI. For example, for periodic or SP CSI resources, the activation indication, in some aspects may be transmitted/received via a MAC-CE or DCI (e.g., a DCI scrambled by SP-CSI-C-RNTI for SP resources) on any active cell for activating the periodic or SP CSI resources. In some aspects, for AP CSI resources, the activation indication may be transmitted/received via DCI (e.g., a DCI scrambled by C-RNTI) on any active cell for activating the AP CSI resources. The activation indication, in some aspects, may activate at least one subset of resources of the set of resources for channel (e.g., CSI) measurement. For example, referring to FIG. 7, the PCell 702 may transmit, and the UE 704 may receive, the channel measurement resource activation 710 indicating for the UE 704 to activate the subsets of resources 707b and 707c associated with deactivated cells 706b and 706c, respectively. In some aspects, a timing between receiving the activation indication and activating the at least one subset of resources occurs may be based on a fixed timing offset (e.g., based on a number of slots, symbols, or milliseconds).

At 1508, the base station may receive, based on the set of resources, information regarding the measured CSI for at least one deactivated cell in the set of deactivated cells of candidate cell. For example, 1508 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. The information regarding the measured CSI for the at least one deactivated cell, in some aspects, may include CSI for each deactivated cell for which CSI was measured and/or obtained. For example, referring to FIG. 7, the PCell 702 may receive, and the UE 704 may transmit, CSI indication 720.

In some aspects, the base station may update a configuration of the candidate cells. The updated configuration, in some aspects, may include one or more of an update to the candidate cells, an update to the designation (e.g., as PCell, SpCell, SCell, PSCell, etc.) of one or more candidate cells, or a configuration of a deactivated cell of the candidate cells. For example, the updated configuration may include a configuration related to a beam for communication with a particular deactivated cell. The update, in some aspects, may be triggered based on a handover initiation. The update, in some aspects, may be based on a set of transmissions between the active cell (e.g., a PCell) and a deactivated cell (e.g., a PSCell). The update, in some aspects, may be based on a set of transmissions between the active cell and a measured (deactivated) cell (e.g., a PSCell transitioning to be a PCell) including a handover indication and/or a reconfiguration information. For example, referring to FIG. 7, the PCell 702 may update a candidate cell configuration designation at 724, where the updated candidate cell configuration designation may be based on (1) a handover initiation 722 that may be initiated based on a movement of the PCell 702 or some other factor (e.g., increased relative performance of a candidate (e.g., an SCell or PSCell) cell in relation to the UE 704) and (2) the set of transmissions between the PCell 702 and a measured cell 706b (e.g., a PSCell transitioning to be a PCell) including a handover indication 724A and/or a reconfiguration information 724B.

Finally, the base station may transmit an indication of the updated configuration of the candidate cells. The updated configuration, in some aspects, may include one or more of an update to the candidate cells, an update to the designation (e.g., as PCell, SpCell, SCell, PSCell, etc.) of one or more candidate cells, or a configuration of a deactivated cell of the candidate cells. For example, referring to FIG. 7, the PCell 702 may transmit, and the UE 704 may receive, the updated candidate cell configuration indication 726.

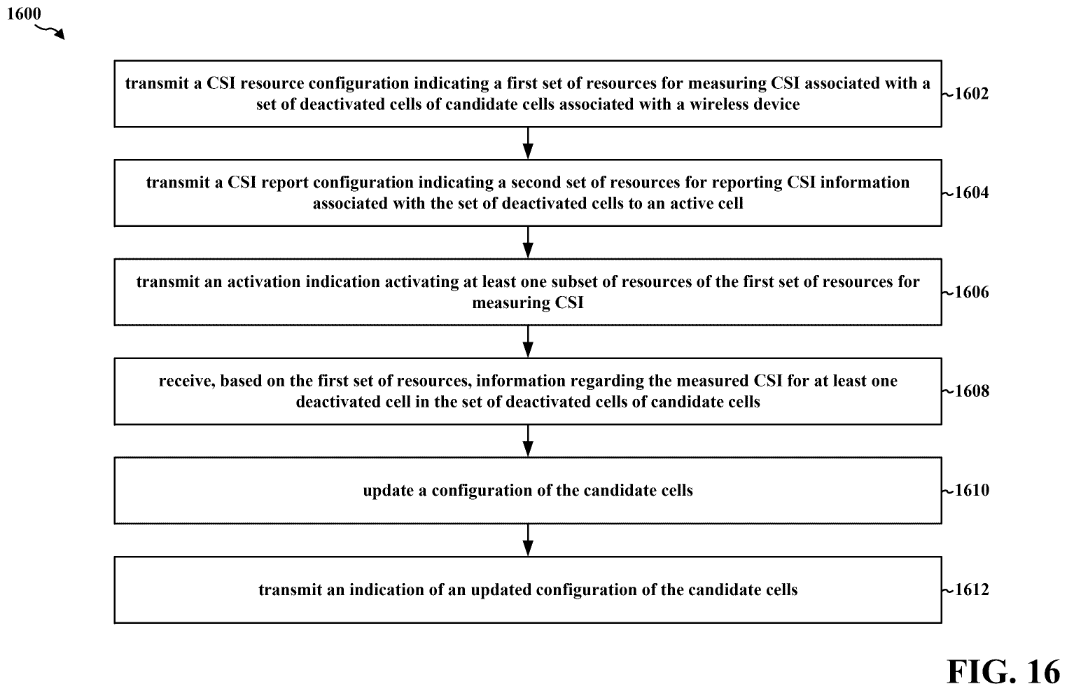

FIG. 16 is a flowchart 1600 of a method of wireless communication. The method may be performed by a base station as an example of an active cell (e.g., the base station 102; the SpCell 402, 502; the PCell 602, 702; the network entity 1802 or 1960). At 1602, the base station may transmit a CSI resource configuration indicating a first set of resources for measuring CSI associated with a corresponding set of deactivated candidate cells associated with the wireless device for L1/L2 mobility. For example, 1602 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. In some aspects, the first set of resources may the set of resources includes at least one of channel measurement resources or interference measurement resources. The indication of the first set of resources, in some aspects, may be based on a set of CORESETs for a corresponding set of CORESET pool indexes associated with at least one deactivated cell of a candidate cell. In some aspects, the set of resources is periodic and QCL with a QCL assumption of the CORESET. For example, referring to FIG. 7, PCell 702 may receive, and UE 704 may receive, channel measurement resource configuration 708 indicating a set of resources 707 for channel measurement for a corresponding set of deactivated cells of candidate cells (e.g., cells 706a-706c) associated with the UE 704. The channel measurement resource configuration 708, in some aspects, may be one of (1) transmitted/received via a RRC signal, (2) known, or (3) an update to a previously-received indication of a different set of resources transmitted/received via a MAC-CE.

The indication of the first set of resources, in some aspects, may include an indication of a plurality of subsets of resources. In some aspects, each subset of resources may be associated with a particular deactivated cell in the set of deactivated cells. For example, the subset of resources 707a may be associated with cell 706a, the subset of resources 707b may be associated with cell 706b, and the subset of resources 707c may be associated with cell 706c. In some aspects, at least two of the plurality of subsets of resources are associated with different TRPs of a same deactivated cell. For example, channel measurement resource configuration 708 (e.g., the indication of the set of resources) may include at least two subsets of resources associated with different TRPs of a same deactivated cell (e.g., if any two of cells 706a-706c represent different TRPs of a same deactivated network node/cell).

At 1604, the base station may transmit a CSI report configuration indicating a second set of resources for reporting CSI information associated with the corresponding set of deactivated cells to an active cell. For example, 1604 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. The CSI report configuration, in some aspects, may indicate one of a set of periodic resources, a set of semi-persistent resources, or a set of aperiodic resources for transmitting the information regarding the measured CSI for the at least one deactivated cell. The CSI report configuration may include a modified CSI-ReportConfig IE. The CSI-ReportConfig IE may include a field (e.g., a “carrier” field) that, in some aspects, may include a cell index associated with one or more (non-PCell) deactivated and/or candidate cells that are associated with a wireless device. In some aspects, the CSI report configuration may indicate a set of semi-persistent resources associated with a PUCCH and the CSI report configuration may be received via a MAC-CE associated with an active cell. The CSI report configuration, in some aspects, may indicate one of a set of semi-persistent resources associated with a PUSCH or a set of aperiodic resources associated with the PUSCH and the CSI report configuration may be received via DCI (e.g., a DCI scrambled by SP-CSI-C-RNTI for SP resources or a DCI scrambled by C-RNTI for AP resources) associated with an active cell. For example, referring to FIGS. 7 and 8, the PCell 702 may transmit, and the UE 704 may receive, the CSI report configuration indication 705 that may include a CSI-ReportConfig IE 801. As discussed above in relation to FIG. 7, receiving the CSI resource configuration at #1602 may be based on receiving the CSI resource configuration included or indicated in the CSI report configuration (e.g., a CSI-ReportConfig IE).

At 1606, the base station may transmit an activation indication activating at least one subset of resources of the first set of resources for measuring CSI. For example, 1606 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. In some aspects, the activation indication may be transmitted/received via one of (1) a MAC-CE or (2) DCI. For example, for periodic or SP CSI resources, the activation indication, in some aspects may be transmitted/received via a MAC-CE or DCI (e.g., a DCI scrambled by SP-CSI-C-RNTI for SP resources) on any active cell for activating the periodic or SP CSI resources. In some aspects, for AP CSI resources, the activation indication may be transmitted/received via DCI (e.g., a DCI scrambled by C-RNTI) on any active cell for activating the AP CSI resources. The activation indication, in some aspects, may activate at least one subset of resources of the set of resources for channel (e.g., CSI) measurement. For example, referring to FIG. 7, the PCell 702 may transmit, and the UE 704 may receive, the channel measurement resource activation 710 indicating for the UE 704 to activate the subsets of resources 707b and 707c associated with deactivated cells 706b and 706c, respectively. In some aspects, a timing between receiving the activation indication and activating the at least one subset of resources occurs may be based on a fixed timing offset (e.g., based on a number of slots, symbols, or milliseconds).

At 1608, the base station may receive, based on the set of resources, information regarding the measured CSI for at least one deactivated cell in the set of deactivated cells of candidate cell. For example, 1608 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. The information regarding the measured CSI for the at least one deactivated cell, in some aspects, may include CSI for each deactivated cell for which CSI was measured and/or obtained. For example, referring to FIG. 7, the PCell 702 may receive, and the UE 704 may transmit, CSI indication 720.

At 1610, the base station may update a configuration of the candidate cells. For example, 1610 may be performed by CU processor 1812, DU processor 1832, RU processor 1842, network processor 1812, and/or deactivated cell RS configuration component 199 of FIGS. 18 and 19. The updated configuration, in some aspects, may include one or more of an update to the candidate cells, an update to the designation (e.g., as PCell, SpCell, SCell, PSCell, etc.) of one or more candidate cells, or a configuration of a deactivated cell of the candidate cells. For example, the updated configuration may include a configuration related to a beam for communication with a particular deactivated cell. The update at 1610, in some aspects, may be triggered based on a handover initiation. The update, in some aspects, may be based on a set of transmissions between the active cell (e.g., a PCell) and a deactivated cell (e.g., a PSCell). The update, in some aspects, may be based on a set of transmissions between the active cell and a measured (deactivated) cell (e.g., a PSCell transitioning to be a PCell) including a handover indication and/or a reconfiguration information. For example, referring to FIG. 7, the PCell 702 may update a candidate cell configuration designation at 724, where the updated candidate cell configuration designation may be based on (1) a handover initiation 722 that may be initiated based on a movement of the PCell 702 or some other factor (e.g., increased relative performance of a candidate (e.g., an SCell or PSCell) cell in relation to the UE 704) and (2) the set of transmissions between the PCell 702 and a measured cell 706b (e.g., a PSCell transitioning to be a PCell) including a handover indication 724A and/or a reconfiguration information 724B.

Finally, at 1612, the base station may transmit an indication of the updated configuration of the candidate cells. For example, 1612 may be performed by CU processor 1812, DU processor 1832, RU processor 1842, network processor 1812, transceiver(s) 1846, antennas 1880, network interface 1980, and/or deactivated cell RS configuration component 199 of FIGS. 18 and 19. The updated configuration, in some aspects, may include one or more of an update to the candidate cells, an update to the designation (e.g., as PCell, SpCell, SCell, PSCell, etc.) of one or more candidate cells, or a configuration of a deactivated cell of the candidate cells. For example, referring to FIG. 7, the PCell 702 may transmit, and the UE 704 may receive, the updated candidate cell configuration indication 726.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the deactivated cell RS configuration component 198 may be configured to receive a first indication of a set of resources for monitoring for a failure event associated with a corresponding set of deactivated cells of candidate cells associated with the wireless device for L1/L2 mobility. The deactivated cell RS configuration component 198 may further be configured to detect a failure event associated with a beam of at least one deactivated cell in the set of deactivated cells of candidate cells by monitoring the set of resources and transmit, for an active cell, a second indication of the detected failure event. In some aspects the deactivated cell RS configuration component 198 may be configured to receive a CSI resource configuration indicating a set of resources for measuring CSI associated with a corresponding set of deactivated candidate cells associated with the wireless device for L1/L2 mobility. The deactivated cell RS configuration component 198 may further be configured to measure, based on the CSI resource configuration indicating the set of resources, CSI associated with resources in the set of resources for at least one deactivated cell in the set of deactivated candidate cells and transmit, for an active cell, information regarding the measured CSI for the at least one deactivated cell. The deactivated cell RS configuration component 198 may be within the cellular baseband processor 1724, the application processor 1706, or both the cellular baseband processor 1724 and the application processor 1706. The deactivated cell RS configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for receiving a first indication of a set of resources for monitoring for a failure event associated with a corresponding set of deactivated cells of candidate cells associated with the wireless device for L1/L2 mobility; means for receiving an activation indication activating at least one subset of resources of the set of resources for monitoring for the failure event; means for monitoring the at least one subset of resources of the set of resources for monitoring for the failure event; means for detecting a failure event associated with a beam of at least one deactivated cell in the set of deactivated cells of candidate cells by monitoring the indicated set of resources; means for transmitting, for an active cell, an indication of the detected failure event; means for receiving a third indication of an updated configuration of the candidate cells; means for receiving a CSI resource configuration indicating a first set of resources for measuring CSI associated with a corresponding set of deactivated candidate cells associated with the wireless device for L1/L2 mobility; means for receiving an activation indication activating at least one subset of resources of the first set of resources for measuring CSI; means for receiving a CSI report configuration indicating a second set of resources for reporting CSI information associated with the corresponding set of deactivated cells to an active cell; means for measuring, based on the CSI resource configuration indicating the first set of resources, CSI associated with resources in the first set of resources for at least one deactivated cell in the set of deactivated candidate cells; means for transmitting, for an active cell, information regarding the measured CSI for the at least one deactivated cell; and means for receiving an indication of an updated configuration of the candidate cells. The means may be the deactivated cell RS configuration component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the deactivated cell RS configuration component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the deactivated cell RS configuration component 199 may be configured to transmit a first indication of a set of resources for monitoring for a failure event associated with a corresponding set of deactivated cells of candidate cells associated with a wireless device for L1/L2 mobility and receive, based on the set of resources, a second indication of a detected failure event associated with a beam of at least one deactivated cell in the set of deactivated cell of candidate cells and the wireless device. The deactivated cell RS configuration component 199 may additionally, or alternatively, be configured to transmit a CSI resource configuration indicating a set of resources for measuring CSI associated with a corresponding set of deactivated candidate cells associated with a wireless device for L1/L2 mobility and receive, based on the set of resources, information regarding the measured CSI for at least one deactivated cell. The component 199 may be within one or more processors of one or more of the CU 1810, DU 1830, and the RU 1840. The deactivated cell RS configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for transmitting a first indication of a set of resources for monitoring for a failure event associated with a corresponding set of deactivated cells of candidate cells associated with the wireless device for L1/L2 mobility; means for transmitting an activation indication activating at least one subset of resources of the set of resources for monitoring for the failure event; means for receiving, based on the set of resources, a second indication of a detected failure event associated with a beam of at least one deactivated cell in the set of deactivated cells of the candidate cells and the wireless device; means for updating a configuration of the candidate cells; means for transmitting a third indication of the updated configuration of the candidate cells; means for transmitting a CSI resource configuration indicating a first set of resources for measuring CSI associated with a corresponding set of deactivated candidate cells associated with the wireless device for L1/L2 mobility; means for transmitting an activation indication activating at least one subset of resources of the first set of resources for measuring CSI; means for transmitting a CSI report configuration indicating a second set of resources for reporting CSI information associated with the corresponding set of deactivated cells to an active cell; means for receiving, based on the set of resources, information regarding the measured CSI for at least one deactivated cell in the set of deactivated cells of candidate cell; means for updating a configuration of the candidate cells; and means for transmitting an indication of the updated configuration of the candidate cells. The means may be the deactivated cell RS configuration component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 19 is a diagram 1900 illustrating an example of a hardware implementation for a network entity 1960. In one example, the network entity 1960 may be within the core network 120. The network entity 1960 may include a network processor 1912. The network processor 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The processor 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the deactivated cell RS configuration component 199 may be configured to transmit a first indication of a set of resources for monitoring for a failure event associated with a corresponding set of deactivated cells of candidate cells associated with a wireless device for L1/L2 mobility and receive, based on the set of resources, a second indication of a detected failure event associated with a beam of at least one deactivated cell in the set of deactivated cell of candidate cells and the wireless device. The deactivated cell RS configuration component 199 may additionally, or alternatively, be configured to transmit a CSI resource configuration indicating a set of resources for measuring CSI associated with a corresponding set of deactivated candidate cells associated with a wireless device for L1/L2 mobility and receive, based on the set of resources, information regarding the measured CSI for at least one deactivated cell. The deactivated cell RS configuration component 199 may be within the processor 1912. The deactivated cell RS configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 includes means for transmitting a first indication of a set of resources for monitoring for a failure event associated with a corresponding set of deactivated cells of candidate cells associated with the wireless device for L1/L2 mobility; means for transmitting an activation indication activating at least one subset of resources of the set of resources for monitoring for the failure event; means for receiving, based on the set of resources, a second indication of a detected failure event associated with a beam of at least one deactivated cell in the set of deactivated cells of the candidate cells and the wireless device; means for updating a configuration of the candidate cells; means for transmitting a third indication of the updated configuration of the candidate cells; means for transmitting a CSI resource configuration indicating a first set of resources for measuring CSI associated with a corresponding set of deactivated candidate cells associated with the wireless device for L1/L2 mobility; means for transmitting an activation indication activating at least one subset of resources of the first set of resources for measuring CSI; means for transmitting a CSI report configuration indicating a second set of resources for reporting CSI information associated with the corresponding set of deactivated cells to an active cell; means for receiving, based on the set of resources, information regarding the measured CSI for at least one deactivated cell in the set of deactivated cells of candidate cell; means for updating a configuration of the candidate cells; and means for transmitting an indication of the updated configuration of the candidate cells. The means may be the deactivated cell RS configuration component 199 of the network entity 1960 configured to perform the functions recited by the means.

In some aspects, of wireless communication, a single wireless device may be associated with multiple different cells (e.g., one or more network nodes or TRPs in each of the different cells). The different cells (or network nodes) may be candidate cells that may be selected to act as one of a primary cell (PCell), a secondary cell (SCell), a primary secondary cell (PSCell), or a special cell (SpCell). In some aspects, a Pcell or SpCell may provide a control plane connection to a core network while an SCell or PSCell may provide additional communication resources to the wireless device (e.g., for multi radio dual connectivity). In some aspects, an SCell or PSCell may be deactivated. For example, if the additional communication resources are not needed, an SCell or PSCell may be temporarily deactivated.

While deactivated, the wireless device may experience (or be subject to) a beam failure or radio link failure with one or more SCells or PSCells. The beam and/or radio link failure may not be detected by the wireless device until the wireless device attempts to activate a deactivated SCell and/or PSCell. A time taken to activate the deactivated SCell and/or PSCell (e.g., a latency of the activation) after an undetected failure event may be larger than an expected time for activating a deactivated SCell and/or PSCell with a functioning beam and/or radio link. The additional latency, in some, aspects, may affect communication via the set of active (or activated) cells.

Additionally, or alternatively, the wireless device, in some aspects, may experience a L1/L2 mobility event (e.g., a change of position or orientation relative to a set of cells or candidate cells associated with the wireless device). During the mobility event, the different cells may become more or less favorable/desirable for serving as a PCell, SpCell, SCell, or PSCell based on distance and/or channel quality (e.g., based on physical blockages, orientation, etc.). As for beam and/or radio link failure, the change in the favorability/desirability of a deactivated SCell and/or PCell, e.g., a change in channel quality, may not be detected by the wireless device until the wireless device attempts to activate a deactivated SCell and/or PSCell. The deactivated SCell and/or PSCell selected for activation, in some aspects, may be based on inaccurate (e.g., out-of-date) information and may lead to the selection of a non-optimal deactivated SCell and/or PSCell for activation. Additionally, beam management for selecting a beam for the SCell and/or PSCell selected for activation may introduce additional time (e.g., additional latency) between activation of, and communication with, the SCell and/or PSCell selected for activation.

In some aspects of the disclosure, a method and apparatus are presented that configure resources for performing, for a wireless device, beam failure and/or radio link failure detection for deactivated network nodes associated with candidate cells associated with the wireless device. By reporting failure of a beam and/or radio link of a deactivated network node, the network and/or wireless device may be able to make a more optimal selection of a cell and/or network node to activate or to designate as a SCell or PSCell. The more optimal selection may be a selection that reduces a latency associated with activating a selected, deactivated network node and/or cell or a handover to a SCell or PSCell to act as a PCell or SpCell.

A method and apparatus, in some aspects of the disclosure, are presented that configure resources for a wireless device for (1) performing channel measurements (e.g., associated with CSI) and (2) reporting CSI for deactivated network nodes associated with candidate cells associated with the wireless device. By reporting the CSI associated with the deactivated network nodes associated with the candidate cells, the network and/or wireless device may be able to make a more optimal selection of a cell and/or network node to activate and or designate as a PCell. For example, the latency time (e.g., including a beam training time) or the channel quality may be optimized when selecting a deactivated network node to activate or a candidate cell to designate as a PCell.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a first indication of a set of resources for monitoring for a failure event associated with a set of deactivated cells of candidate cells associated with the wireless device for L1/L2 mobility; detecting a failure event associated with a beam of at least one deactivated cell in the set of deactivated cells of the candidate cells by monitoring the set of resources; and transmitting, for an active cell, a second indication of the detected failure event.

Aspect 2 is the method of aspect 1, where the set of resources includes reference signal resources for the set of deactivated cells.

Aspect 3 is the method of any of aspects 1 and 2, where the first indication of the set of resources indicates a plurality of subsets of resources, where each subset of resources is associated with a particular deactivated cell in the set of deactivated cells.

Aspect 4 is the method of aspect 3, where at least two of the plurality of subsets of resources are associated with different TRPs of a same deactivated cell.

Aspect 5 is the method of any of aspects 3 and 4, further including receiving an activation indication activating at least one subset of resources of the set of resources for monitoring for the failure event, where the failure event associated with the at least one deactivated cell in the set of deactivated cells is detected by monitoring the at least one subset of resources.

Aspect 6 is the method of aspect 5, where a timing between receiving the activation indication and activating the at least one subset of resources occurs is based on a fixed timing offset.

Aspect 7 is the method of any of aspects 5 and 6, further including performing a prioritization operation over the at least one subset of resources of the set of resources for monitoring for the failure event and a different set of resources for monitoring for a failure associated with the active cell to ensure that the at least one subset of resources of the set of resources for monitoring for the failure event and the different set of resources for monitoring for the failure associated with the active cell include no more than a maximum number of resources based on a capability of the wireless device.

Aspect 8 is the method of any of aspects 1 to 7, where the first indication of the set of resources is based on a set of CORESETs for a corresponding set of CORESET pool indexes associated with the set of deactivated cells of the candidate cells.

Aspect 9 is the method of aspect 8, where the set of resources is periodic and has a same QCL assumption as a CORESET in the set of CORESETs.

Aspect 10 is a method of wireless communication at a UE, including receiving a CSI resource configuration indicating a set of resources for measuring CSI associated with a set of deactivated candidate cells associated with the wireless device for L1/L2 mobility; measuring, based on the CSI resource configuration indicating the set of resources, CSI associated with resources in the set of resources for at least one deactivated cell in the set of deactivated candidate cells; and transmitting, for an active cell, information regarding the measured CSI for the at least one deactivated cell.

Aspect 11 is the method of aspect 10, where the set of resources includes at least one of channel measurement resources or interference measurement resources.

Aspect 12 is the method of any of aspects 10 and 11, where the CSI resource configuration indicating the set of resources includes an indication of a plurality of subsets of resources, each subset of resources is associated with a particular deactivated cell in the set of deactivated candidate cells, and each subset of resources includes one of periodic resources, semi-persistent resources, or aperiodic resources.

Aspect 13 is the method of aspect 12 further including receiving an activation indication activating at least one subset of resources of the set of resources for measuring CSI, where the at least one subset of resources corresponds to the at least one deactivated cell, where the activation indication is received via one of a MAC-CE or DCI.

Aspect 14 is the method of any of aspects 12 and 13 further including receiving a CSI report configuration indicating one of a set of periodic resources, a set of semi-persistent resources, or a set of aperiodic resources for transmitting the information regarding the measured CSI for the at least one deactivated cell.

Aspect 15 is the method of aspect 14, where the CSI report configuration indicates a set of semi-persistent resources associated with a PUCCH and the CSI report configuration is received via a MAC-CE associated with the active cell.

Aspect 16 is the method of aspect 14, where the CSI report configuration indicates one of a set of semi-persistent resources associated with a PUSCH or a set of aperiodic resources associated with the PUSCH and the CSI report configuration is received via DCI associated with an active cell.

Aspect 17 is the method of any of aspects 14 to 16, where the CSI report configuration includes a cell index associated with the at least one deactivated cell.

Aspect 18 a method of wireless communication at a network node, including transmitting a first indication of a set of resources for monitoring for a failure event associated with a set of deactivated cells of candidate cells associated with a wireless device for L1/L2 mobility and receiving, based on the set of resources, a second indication of a detected failure event associated with a beam of at least one deactivated cell in the set of deactivated cells of the candidate cells and the wireless device.

Aspect 19 is the method of aspect 18, where the set of resources includes reference signal resources for the set of deactivated cells.

Aspect 20 is the method of any of aspects 18 and 19, where the first indication of the set of resources indicates a plurality of subsets of resources, where each subset of resources is associated with a particular deactivated cell in the set of deactivated cells.

Aspect 21 is the method of aspect 20, where at least two of the plurality of subsets of resources are associated with different TRPs of a same deactivated cell.

Aspect 22 is the method of any of aspects 20 and 21, further including transmitting an activation indication activating at least one subset of resources of the set of resources for monitoring for the failure event, where the second indication is based on the at least one subset of resources.

Aspect 23 is the method of any of aspects 18 to 22, where the indication of the set of resources is based on a set of CORESETs for a corresponding set of CORESET pool indexes associated with the set of deactivated cells of the candidate cells.

Aspect 24 is the method of aspect 23, where the set of resources is periodic and has a same QCL assumption as a CORESET in the set of CORESETs.

Aspect 25 is a method of wireless communication at a network node, including transmitting a CSI resource configuration indicating a set of resources for measuring CSI associated with a set of deactivated candidate cells associated with a wireless device for L1/L2 mobility and receiving, based on the set of resources, information regarding the measured CSI for at least one deactivated cell.

Aspect 26 is the method of aspect 25, where the set of resources includes at least one of channel measurement resources or interference measurement resources.

Aspect 27 is the method of any of aspects 25 and 26, where the CSI resource configuration indicating the set of resources includes an indication of a plurality of subsets of resources, each subset of resources is associated with a particular deactivated cell in the set of deactivated candidate cells, and each subset of resources includes one of periodic resources, semi-persistent resources, or aperiodic resources.

Aspect 28 is the method of aspect 27 further including transmitting an activation indication activating at least one subset of resources of the set of resources for measuring CSI, where the at least one subset of resources corresponds to the at least one deactivated cell, where the activation indication is transmitted via one of a MAC-CE or DCI.

Aspect 29 is the method of any of aspects 27 and 28 further including transmitting a CSI report configuration indicating one of a set of periodic resources, a set of semi-persistent resources, or a set of aperiodic resources for transmitting the information regarding the measured CSI for the at least one deactivated cell.

Aspect 30 is the method of aspect 29, where the CSI report configuration indicates a set of semi-persistent resources associated with a PUCCH and the CSI report configuration is received via a MAC-CE associated with active cell.

Aspect 31 is the method of aspect 29, where the CSI report configuration indicates one of a set of semi-persistent resources associated with a PUSCH or a set of aperiodic resources associated with the PUSCH and the CSI report configuration is received via DCI associated with an active cell.

Aspect 32 is the method of any of aspects 14 to 16, where the CSI report configuration includes a cell index associated with the at least one deactivated cell.

Aspect 33 is an apparatus for wireless communication at a device including a memory and at least one processor coupled to the memory and, based at least in part on information stored in the memory, the at least one processor is configured to implement any of aspects 1 to 9.

Aspect 34 is an apparatus for wireless communication at a device including means for implementing any of aspects 1 to 9.

Aspect 35 is the apparatus of aspect 33 or 34, further including a transceiver or an antenna.

Aspect 36 is a computer-readable medium (e.g., a non-transitory computer-readable medium) storing computer executable code, where the code when executed by a processor causes the processor to implement any of aspects 1 to 9.

Aspect 37 is an apparatus for wireless communication at a device including a memory and at least one processor coupled to the memory and, based at least in part on information stored in the memory, the at least one processor is configured to implement any of aspects 10 to 17.

Aspect 38 is an apparatus for wireless communication at a device including means for implementing any of aspects 10 to 17.

Aspect 39 is the apparatus of aspect 38 or 39, further including a transceiver or an antenna.

Aspect 40 is a computer-readable medium (e.g., a non-transitory computer-readable medium) storing computer executable code, where the code when executed by a processor causes the processor to implement any of aspects 10 to 17.

Aspect 41 is an apparatus for wireless communication at a device including a memory and at least one processor coupled to the memory and, based at least in part on information stored in the memory, the at least one processor is configured to implement any of aspects 18 to 24.

Aspect 42 is an apparatus for wireless communication at a device including means for implementing any of aspects 18 to 24.

Aspect 43 is the apparatus of aspect 41 or 42, further including a transceiver or an antenna.

Aspect 44 is a computer-readable medium (e.g., a non-transitory computer-readable medium) storing computer executable code, where the code when executed by a processor causes the processor to implement any of aspects 18 to 24.

Aspect 45 is an apparatus for wireless communication at a device including a memory and at least one processor coupled to the memory and, based at least in part on information stored in the memory, the at least one processor is configured to implement any of aspects 25 to 32.

Aspect 46 is an apparatus for wireless communication at a device including means for implementing any of aspects 25 to 32.

Aspect 47 is the apparatus of aspect 45 or 46, further including a transceiver or an antenna.

Aspect 48 is a computer-readable medium (e.g., a non-transitory computer-readable medium) storing computer executable code, where the code when executed by a processor causes the processor to implement any of aspects 25 to 32.

What is claimed is:

1. An apparatus for wireless communication at a wireless device, comprising:
a memory; and
at least one processor coupled to the memory and, based at least in part on information stored in the memory, the at least one processor is configured to:
receive a first indication of a set of resources for monitoring for a failure event associated with a set of deactivated cells of candidate cells associated with the wireless device for layer 1 or layer 2 (L1/L2) mobility;
detect the failure event associated with a beam of at least one deactivated cell in the set of deactivated cells of the candidate cells by monitoring the set of resources; and
transmit, for an active cell, a second indication of the detected failure event.

2. The apparatus of claim 1, wherein the set of resources comprises reference signal resources for the set of deactivated cells.

3. The apparatus of claim 1, wherein the first indication of the set of resources indicates a plurality of subsets of resources, wherein each subset of resources is associated with a particular deactivated cell in the set of deactivated cells.

4. The apparatus of claim 3, wherein at least two of the plurality of subsets of resources are associated with different transmission and reception points (TRPs) of a same deactivated cell.

5. The apparatus of claim 3, wherein the at least one processor is further configured to:
receive an activation indication activating at least one subset of resources of the set of resources for monitoring for the failure event, wherein the failure event associated with the at least one deactivated cell in the set of deactivated cells is detected by monitoring the at least one subset of resources.

6. The apparatus of claim 5, wherein a timing between receiving the activation indication and activating the at least one subset of resources occurs is based on a fixed timing offset.

7. The apparatus of claim 5, wherein the at least one processor is further configured to:
perform a prioritization operation over the at least one subset of resources of the set of resources for monitoring for the failure event and a different set of resources for monitoring for a failure associated with an active cell to ensure that the at least one subset of resources of the set of resources for monitoring for the failure event and the different set of resources for monitoring for the failure associated with the active cell comprise no more than a maximum number of resources based on a capability of the wireless device.

8. The apparatus of claim 1, wherein the first indication of the set of resources is based on a set of control resource sets (CORESETs) for a corresponding set of CORESET pool indexes associated with the set of deactivated cells of the candidate cells.

9. The apparatus of claim 8, wherein the set of resources is periodic and has a same quasi co-location (QCL) assumption as a CORESET in the set of CORESETs.

10. An apparatus for wireless communication at a wireless device, comprising:
a memory; and
at least one processor coupled to the memory and, based at least in part on stored information stored in the memory, the at least one processor is configured to:
receive a channel state information (CSI) resource configuration indicating a set of resources for measuring CSI associated with a set of deactivated candidate cells associated with the wireless device for layer 1 or layer 2 (L1/L2) mobility;
measure, based on the CSI resource configuration indicating the set of resources, CSI associated with resources in the set of resources for at least one deactivated cell in the set of deactivated candidate cells; and
transmit, for an active cell, information regarding the measured CSI for the at least one deactivated cell.

11. The apparatus of claim 10, wherein the set of resources includes at least one of channel measurement resources or interference measurement resources.

12. The apparatus of claim 10, wherein the CSI resource configuration indicating the set of resources comprises an indication of a plurality of subsets of resources,
each subset of resources is associated with a particular deactivated cell in the set of deactivated candidate cells, and
each subset of resources comprises one of periodic resources, semi-persistent resources, or aperiodic resources.

13. The apparatus of claim 12, wherein the at least one processor is further configured to:
receive an activation indication activating at least one subset of resources of the set of resources for measuring CSI, wherein the at least one subset of resources corresponds to the at least one deactivated cell, wherein the activation indication is received via one of a media access control (MAC) control element (CE) (MAC-CE) or downlink control information (DCI).

14. The apparatus of claim 12, wherein the at least one processor is further configured to:
receive a CSI report configuration indicating one of a set of periodic resources, a set of semi-persistent resources, or a set of aperiodic resources for transmitting the information regarding the measured CSI for the at least one deactivated cell, wherein the CSI report configuration comprises a cell index associated with the at least one deactivated cell.

15. The apparatus of claim 14, wherein the CSI report configuration indicates the set of semi-persistent resources associated with a physical uplink control channel (PUCCH) and the CSI report configuration is received via a media access control (MAC) control element (CE) (MAC-CE) associated with the active cell.

16. The apparatus of claim 14, wherein the CSI report configuration indicates one of the set of semi-persistent resources associated with a physical uplink shared channel (PUSCH) or the set of aperiodic resources associated with the PUSCH and the CSI report configuration is received via downlink control information (DCI) associated with the active cell.

17. An apparatus for wireless communication at a network node, comprising:
a memory; and
at least one processor coupled to the memory and, based at least in part on information stored in the memory, the at least one processor is configured to:
transmit a first indication of a set of resources for monitoring for a failure event associated with a set of deactivated cells of candidate cells associated with a wireless device for layer 1 or layer 2 (L1/L2) mobility; and
receive, based on the set of resources, a second indication of a detected failure event associated with a beam of at least one deactivated cell in the set of deactivated cells of the candidate cells and the wireless device.

18. The apparatus of claim 17, wherein the set of resources comprises reference signal resources for the set of deactivated cells.

19. The apparatus of claim 17, wherein the first indication of the set of resources indicates a plurality of subsets of resources, wherein each subset of resources is associated with a particular deactivated cell in the set of deactivated cells.

20. The apparatus of claim 19, wherein at least two of the plurality of subsets of resources are associated with different transmission and reception points (TRPs) of a same deactivated cell.

21. The apparatus of claim 19, wherein the at least one processor is further configured to:
transmit an activation indication activating at least one subset of resources of the set of resources for monitoring for the failure event, wherein the second indication is based on the at least one subset of resources.

22. The apparatus of claim 17, wherein the first indication of the set of resources is based on a set of control resource sets (CORESETs) for a corresponding set of CORESET pool indexes associated with the set of deactivated cells of the candidate cells.

23. The apparatus of claim 22, wherein the set of resources is periodic and has a same quasi co-location (QCL) assumption as a CORESET in the set of CORESETs.

24. An apparatus for wireless communication at a network node, comprising:
a memory; and
at least one processor coupled to the memory and, based at least in part on stored information stored in the memory, the at least one processor is configured to:
transmit a channel state information (CSI) resource configuration indicating a set of resources for measuring CSI associated with a set of deactivated candidate cells associated with a wireless device for layer 1 or layer 2 (L1/L2) mobility; and
receive, based on the set of resources, information regarding the measured CSI for at least one deactivated cell.

25. The apparatus of claim 24, wherein the set of resources includes at least one of channel measurement resources or interference measurement resources.

26. The apparatus of claim 24, wherein the CSI resource configuration indicating the set of resources comprises an indication of a plurality of subsets of resources,
each subset of resources is associated with a particular deactivated cell in the set of deactivated candidate cells, and
each subset of resources comprises one of periodic resources, semi-persistent resources, or aperiodic resources.

27. The apparatus of claim 26, wherein the at least one processor is further configured to:
transmitting an activation indication activating at least one subset of resources of the set of resources for measuring CSI, wherein the at least one subset of resources corresponds to the at least one deactivated cell, wherein the activation indication is transmitted via one of a media access control (MAC) control element (CE) (MAC-CE) or downlink control information (DCI).

28. The apparatus of claim 26, further comprising transmitting a CSI report configuration indicating one of a set of periodic resources, a set of semi-persistent resources, or a set of aperiodic resources for transmitting the information regarding the measured CSI for the at least one deactivated cell, wherein the CSI report configuration comprises a cell index associated with the at least one deactivated cell.

29. The apparatus of claim 28, wherein the CSI report configuration indicates the set of semi-persistent resources associated with a physical uplink control channel (PUCCH) and the CSI report configuration is transmitted via a media access control (MAC) control element (CE) (MAC-CE).

30. The apparatus of claim 28, wherein the CSI report configuration indicates one of the set of semi-persistent resources associated with a physical uplink shared channel (PUSCH) or the set of aperiodic resources associated with the PUSCH and the CSI report configuration is transmitted via downlink control information (DCI).
